(19) United States
(12) Patent Application Publication
(10) Pub. No.: US 2024/0414743 A1
(43) Pub. Date: Dec. 12, 2024

(54) MANAGEMENT OF SIDELINK COMMUNICATION USING THE UNLICENSED SPECTRUM

(71) Applicant: Fraunhofer-Gesellschaft zur Förderung der angewandten Forschung e.V., München (DE)

(72) Inventors: Sarun SELVANESAN, Berlin (DE); Baris GÖKTEPE, Berlin (DE); Thomas FEHRENBACH, Berlin (DE); Thomas WIRTH, Berlin (DE); Thomas SCHIERL, Berlin (DE); Cornelius HELLGE, Berlin (DE)

(73) Assignee: Fraunhofer-Gesellschaft zur Förderung der angewandten Forschung e.V., München (DE)

(21) Appl. No.: 18/745,658

(22) Filed: Jun. 17, 2024

Related U.S. Application Data
(63) Continuation of application No. PCT/EP2022/086366, filed on Dec. 16, 2022.

(30) Foreign Application Priority Data
Dec. 17, 2021 (EP) 21215736.6

(51) Int. Cl. H04W 72/25; H04W 72/02

(52) U.S. Cl. CPC H04W 72/25; H04W 72/02

(57) ABSTRACT

A user device, UE, for a wireless communication system, like a 3^{rd} Generation Partnership Project, 3GPP, system is described. The UE is to communicate using a sidelink, SL, using resources allocated by a base station of the wireless communication system. The UE is configured or preconfigured with at least one first SL resource pool including resources in an unlicensed spectrum. The UE is to provide to the base station occupancy information regarding the unlicensed spectrum.

### CROSS-REFERENCE TO RELATED APPLICATIONS

This application is a continuation of copending International Application No. PCT/EP2022/086366, filed Dec. 16, 2022, which is incorporated herein by reference in its entirety, and additionally claims priority from European Application No. 21215736.6, filed Dec. 17, 2021, which is also incorporated herein by reference in its entirety.

### TECHNICAL FIELD

The present invention concerns the field of wireless communication systems or networks, more specifically the direct communication between user devices over a sidelink. Embodiments concern the management of a sidelink communication in the unlicensed spectrum.

### BACKGROUND OF THE INVENTION

FIG. 1A is a schematic representation of an example of a terrestrial wireless network 100 including the core network 102 and one or more radio access networks RAN₁, RAN₂, . . . RAN_{N}. FIG. 1B is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANₙ may include more or less such cells, and RANₙ may also include only one base station. FIG. 1B shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1B shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1B by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 1B by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st} stage SCI, and optionally, a second control region which contains a second part of control information, also referred to as the 2^{nd} stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1A and FIG. 1B may be a heterogeneous network having distinct overlaid networks, e.g., a network of macro cells with each macro cell including a macro base station, like base station gNB₁ to gNB₅, and a network of small cell base stations, not shown in FIG. 1A or FIG. 1B, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1A and FIG. 1B, for example in accordance with the LTE-Advanced Pro standard or the 5G or NR, new radio, standard.

In mobile communication networks, for example in a network like that described above with reference to FIG. 1A and FIG. 1B, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1B. This is referred to as an “in-coverage” scenario. Another scenario is referred to as an “out-of-coverage” scenario. It is noted that “out-of-coverage” does not mean that the two UEs are necessarily outside one of the cells depicted in FIG. 1B, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

FIG. 2A is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1B. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 2B is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 2B which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 2A, in addition to the NR mode 1 or LTE mode 3 UEs 202, 204 also NR mode 2 or LTE mode 4 UEs 206, 208, 210 are present. In addition, FIG. 2B, schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210

Although FIG. 2A and FIG. 2B illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

In the above-described scenarios of vehicular user devices, UEs, a plurality of such user devices may form a user device group, also referred to simply as group, and the communication within the group or among the group members may be performed via the sidelink interfaces between the user devices, like the PC5 interface. For example, the above-described scenarios using vehicular user devices may be employed in the field of the transport industry in which a plurality of vehicles being equipped with vehicular user devices may be grouped together, for example, by a remote driving application. Other use cases in which a plurality of user devices may be grouped together for a sidelink communication among each other include, for example, factory automation and electrical power distribution. In the case of factory automation, a plurality of mobile or stationary machines within a factory may be equipped with user devices and grouped together for a sidelink communication, for example for controlling the operation of the machine, like a motion control of a robot. In the case of electrical power distribution, entities within the power distribution grid may be equipped with respective user devices which, within a certain area of the system may be grouped together so as to communicate via a sidelink communication with each other so as to allow for monitoring the system and for dealing with power distribution grid failures and outages.

It is noted that the information in the above section is only for enhancing the understanding of the background of the invention and, therefore, it may contain information that does not form conventional technology that is already known to a person of ordinary skill in the art.

Starting from the above, there may be a need for improvements or enhancements of the sidelink in a wireless communication system or network.

### SUMMARY

An embodiment may have a user device, UE, for a wireless communication system, like a 3^{rd} Generation Partnership Project, 3GPP, system, wherein the UE is to communicate using a sidelink, SL, using resources allocated by a base station of the wireless communication system, wherein the UE is configured or preconfigured with at least one first SL resource pool and with at least one second SL resource pool, wherein the UE is to receive from the base station, directly or via another UE, a resource allocation for a transmission using the SL, the resource allocation having a plurality of sets of resources from one or more of the first and second SL resource pools, each set of resources available for the UE to carry out the transmission or to be signaled to a further UE as resources available or not available or as a preferred or non-preferred set of resources to be used for a transmission by the further UE, e.g., using an assistance information message, AIM, and wherein the UE is to determine among the plurality of sets of resources an unoccupied set of resources and to carry out the transmission using the unoccupied set of resources or to signal to the further UE the unoccupied set of resources as the available resources.

Another embodiment may have a base station for a wireless communication system, like a 3^{rd} Generation Partnership Project, 3GPP, system, the wireless communication system having a plurality of sidelink user devices, SL-UEs, communicating using a sidelink, SL, wherein the base station is to provide to a SL UE, directly or via another UE, a resource allocation for a transmission by the SL UE using the SL, the resource allocation having a plurality of sets of resources from at least one first SL resource pool and/or from at least one second SL resource pool, each set of resources available for the UE to carry out the transmission or to be signaled to a further UE as resources available for a transmission by the further UE, e.g., using an assistance information message, AIM.

According to another embodiment, a method for operating a method for operating a user device, UE, for a wireless communication system, like a 3^{rd} Generation Partnership Project, 3GPP, system, wherein the UE is to communicate using a sidelink, SL, using resources allocated by a base station of the wireless communication system, and wherein the UE is configured or preconfigured with at least one first SL resource pool and with at least one second SL resource pool, may have the steps of: receiving from the base station, directly or via another UE, a resource allocation for a transmission using the SL, the resource allocation having a plurality of sets of resources from one or more of the first and second SL resource pools, each set of resources available for the UE to carry out the transmission or to be signaled to a further UE as resources available or not available or as a preferred or non-preferred set of resources to be used for a transmission by the further UE, e.g., using an assistance information message, AIM, and determining among the plurality of sets of resources an unoccupied set of resources and to carry out the transmission using the unoccupied set of resources or to signal to the further UE the unoccupied set of resources as the available resources.

### BRIEF DESCRIPTION OF THE DRAWINGS

Embodiments of the present invention are now described in further detail with reference to the accompanying drawings, in which:

FIG. 1A is a schematic representation of an example of a terrestrial wireless network;

FIG. 1B is a schematic representation of an example of a radio access network;

FIG. 2A is a schematic representation of an in-coverage scenario;

FIG. 2B is a schematic representation of an out-of-coverage scenario;

FIG. 3 is a schematic representation of a wireless communication system including a transmitter, like a base station, and one or more receivers, like user devices, UEs, implementing embodiments of the present invention;

FIG. 4 illustrates a user device, UE, and a base station in accordance with an embodiment of the first aspect of the present invention;

FIG. 5 illustrates an embodiment where a UE reports on one or more subbands within the unlicensed spectrum;

FIG. 6 illustrates an embodiment where a UE reports on subbands which belong logically to the same resource pool, but which can be in different physical resources,

FIG. 7 illustrates an embodiment where a UE reports on an unlicensed carrier which the gNB might not be aware of;

FIG. 8 illustrates a user device, UE, and a base station in accordance with an embodiment of the second aspect of the present invention;

FIG. 9 illustrates a user device, UE, and a base station in accordance with an embodiment of the third aspect of the present invention;

FIG. 10 illustrates a staggered use of frequency bands or subbands based on an occupancy status of licensed and/or unlicensed carriers in accordance with embodiments of the third aspect of the present invention;

FIG. 11 illustrates a user device, UE, and a base station in accordance with an embodiment of the fourth aspect of the present invention;

FIG. 12 illustrates an embodiment of the fourth aspect of the present invention providing a UE with several grants available for a given transmission which are not all required since a transmission is completed without using all of the resources in the grants; and

FIG. 13 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

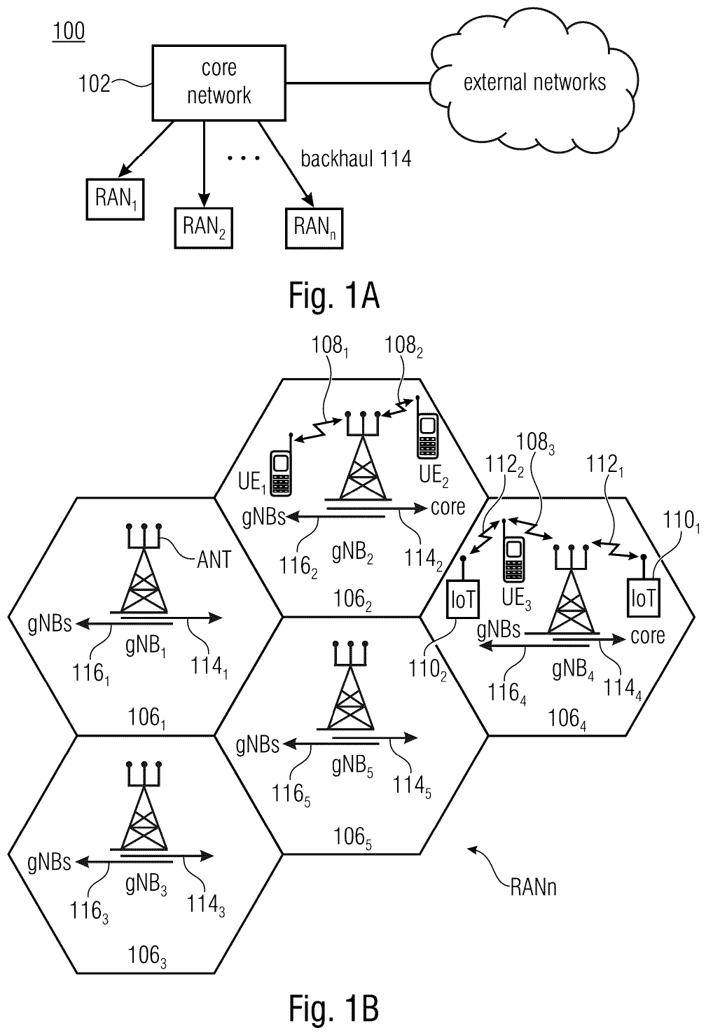

In mobile communication systems or networks, like those described above with reference to FIG. 1A, for example in a LTE or 5G/NR network, the respective entities may communicate using one or more frequency bands. A frequency band includes a start frequency, an end frequency and all intermediate frequencies between the start and end frequencies. In other words, the start, end and intermediate frequencies may define a certain bandwidth, e.g., 20 MHz. A frequency band may also be referred to as a carrier, a bandwidth part, BWP, a subband, and the like.

When using a single frequency band, the communication may be referred to as a single-band operation, e.g., a UE transmits/receives radio signals to/from another network entity on frequencies being within the band, like the 20 MHz band.

When using a two or more frequency bands, the communication may be referred to as a multi-band operation or as a wideband operation or as a carrier aggregation operation. The frequency bands may have different bandwidths or the same bandwidth, like 20 MHz. For example, in case of frequency bands having the same bandwidths a UE may transmit/receive radio signals to/from another network entity on frequencies being within two or more of the 20 MHz bands so that the frequency range for the radio communication may be a multiple of 20 MHz. The two or more frequency bands may be continuous/adjacent frequency bands or some or all for the frequency bands may be separated in the frequency domain.

The multi-band operation may include frequency bands in the licensed spectrum, or frequency bands in the unlicensed spectrum, or frequency bands both in the licensed spectrum and in the unlicensed spectrum.

Carrier aggregation, CA, is an example using two or more frequency bands in the licensed spectrum and/or in the unlicensed spectrum. Also mixed combinations are possible, e.g., one or more frequency bands in licensed and one or more frequency bands in unlicensed bands. Furthermore, CA can also be just used for aggregation of an additional carrier in one direction, e.g., as a supplemental carrier to improve transmissions via UL, DL or SL.

5G New Radio (NR) may support an operation in the unlicensed spectrum so that a single-band operation or a multi-band operation may include frequency bands or subbands in the unlicensed spectrum. The unlicensed spectrum may include bands with a potential IEEE 802.11 coexistence, such as frequency bands within the 5 GHz and/or the 6 GHz spectrum. NR-U may support bandwidths that are an integer multiple of 20 MHz, for example due to regulatory requirements. The splitting into the subbands may be performed so as to minimize interference with coexisting systems, like IEE 802.11 systems, which may operate in one or more of the same bands with the same nominal bandwidth channels, like 20 MHz channels. Other examples, of coexisting systems may use subbands having subband sizes and nominal frequencies different from the above-described IEEE 802.11 systems. For example, the unlicensed spectrum may include the 5 GHz band, the 6 GHz band, the 24 GHz band or the 60 GHz band. Examples of such unlicensed bands include the industrial, scientific and medical, ISM, radio bands reserved internationally for the use of radio frequency energy for industrial, scientific and medical purposes other than telecommunications.

During an operation using unlicensed subbands, Listen-before-talk, LBT, may be performed separately per subband. This may lead to a situation in which one or more of the subbands are busy or occupied due to an interference, for example, from other communication systems coexisting on the same band, like other public land mobile networks, PLMNs or systems operating in accordance with the IEEE 802.11 specification or operating under the ETSI Broadband Radio Access Networks, BRAN, specifications. In such a situation, the transmitter, either the transmitting gNB or the transmitting UE, is only allowed to transmit on the subbands which are detected to be not busy, also referred to as subbands being free or non-occupied. For example, for a transmission spanning more than 20 MHz in the 5 GHz operational unlicensed band, the transmitter, like the gNB or the UE, performs Listen-Before-Talk, LBT, separately on each subband. Once the LBT results are available for each subband, the devices, for example, the gNB in the downlink, DL, or the UE in the uplink, UL, are allowed to transmit on those subbands which are determined to be free or unoccupied, i.e., to transmit on the won subband(s). No transmission is allowed on the occupied, busy, or non-won subbands.

As mentioned above, user devices may communicate directly with each other using the sidelink. In addition to implementing a sidelink communication in the licensed spectrum, also a sidelink communication may be implemented in the non-licensed or unlicensed spectrum. For example, one or more unlicensed subbands may be used for a sidelink communication between two user devices. Stated differently, the sidelink, in addition to being implemented in the licensed spectrum, may also be implemented in the unlicensed spectrum. When considering a UE operating in-coverage, for example when operating in the NR V2X Mode 1, the base station or gNB serving the sidelink user device, SL-UE, allocates to the SL-UE the resources to use for a sidelink communication. For example, when considering NR V2X use cases, a diverse array of periodic and aperiodic message types may be employed for the resource allocation. For example, a resource allocation Mode 1 provides for dynamic grants, DGs, of resources to be used for the sidelink communication, also referred to as sidelink dynamic grants, as well as grants of periodic sidelink resources configured semi-statically by RRC, also referred to as sidelink configured grants, CGs. By means of a sidelink DG a serving gNB may provide resources for one or multiple transmissions of a transport block, TB, for example to allow controlling the reliability of the transmissions. A transmission may be subject to a sidelink hybrid automatic repeat request, HARQ, procedure. On the other hand, a sidelink CG may be configured once and may be used by the SL-UE immediately until it is released by RRC signaling. Such a configured grant is also known as Type 1 CG. A SL-UE is allowed to continue using the Type 1 CG if a beam failure or a physical layer problem occurs over the interface between the SL-UE and the gNB, like the NR Uu interface, until a radio link failure, RLF, detection timer expires. Once the RLF detection timer expires, the UE may make use of resources from an exceptional resource pool with which the UE is configured or preconfigured so as to allow the UE to make use of specific resources in exceptional situations, like a radio link failure. Another type of a sidelink CG, also known as Type 2 CG, is configured once but may not be used by the SL-UE until the gNB sends a DCI over the Uu interface indicating that this configured grant is now active. The resources configured by the Type 2 CG may be used until another DCI indicates a deactivation. The resources in both types are a set of sidelink resources recurring with a periodicity which a gNB desires to match the characteristics of the V2X traffic. Multiple configured grants may be configured to allow provisioning for different services, traffic types and the like.

Information on the modulation and coding scheme, MCS, to be used for the dynamic and configured grants may optionally be provided or constrained by RRC signalling instead of using conventional downlink control information, DCI. RRC signalling may be used to configure the MCS that a transmitting SL-UE UE uses, or a range of available MCSs may be configured. In other examples, the MCS may not be configured and the transmitting UE may select an appropriate MCS based on the knowledge the UE has about the TB to be transmitted and, optionally, certain sidelink radio conditions.

The gNB scheduling activity may be driven by the UE which reports its sidelink traffic characteristics or by performing a sidelink buffer status report, BSR, procedure similar to that on the Uu interface for requesting a sidelink resource allocation from the gNB.

The above-described exemplary processes and procedures carried out by the gNB for allocating resources may also be referred to as a kind of management of the sidelink communication by the gNB. Conventionally, the wireless communication system operates in a licensed spectrum, i.e., makes use of frequencies, frequency bands or subbands that are exclusively provided for the wireless communication system, for example a 3GPP system, so that the gNB is aware of the resources available in the respective frequency bands. Based on this knowledge, conventionally, the gNB may provide resource allocation information to the SL-UE responsive to a request from the SL-UE for a grant from the gNB. The gNB may provide either the above-mentioned dynamic grants using DCIs or the above-mentioned configured grants using higher layer signaling. This is an easy task for the gNB in the NR V2X Mode 1 scenario when operating in the licensed band because the gNB is the only entity controlling the resource allocation in a resource pool providing resources in the licensed band. Note, the gNB does not need to be limited to operate in the licensed spectrum, but could also operate in an unlicensed band, which is known as NR-U in 5G. In this case, the gNB could also forward channel occupancy times to other UEs, or provide resource to another UE, depending on its knowledge of the occupancy on the unlicensed carrier.

However, when extending the sidelink communication into the unlicensed spectrum, the communication over the sidelink may take place also in the unlicensed spectrum which is not only used by the wireless communication system but also by other systems that may use different radio access techniques RATs. In other words, the unlicensed band is not used by the 3GPP RAT alone, rather, in the unlicensed spectrum, it is necessary to compete for resources with other RATs, such as WiFi and/or Bluetooth. Moreover, it may even be necessary to compete for access to resources in the unlicensed spectrum with a system of the same radio access technology that is operated by a different operator. In other words, there may be two or more wireless communication systems of different operators using the same radio access technology, RAT, for example several 3GPP wireless communication systems of different operators which all may use the unlicensed spectrum. However, the unlicensed spectrum may be used for different purposes so that in such a scenario, as mentioned, a certain 3GPP wireless communication network not only competes for the resources in the unlicensed band with different RATs but also with other 3GPP wireless communication networks of other operators. For example, in a first 3GPP wireless communication system the unlicensed spectrum may be used for V2X UEs, whereas another 3GPP wireless communication system may use the unlicensed spectrum for backhaul traffic. Thus, a sidelink communication in the unlicensed spectrum, for example in a certain unlicensed band, may collide with the backhaul traffic of another network operator.

Thus, there is a need for providing improvements or enhancements of the sidelink communication in a wireless communication network employing resources in an unlicensed spectrum for the sidelink communication. Furthermore, embodiments of this invention improve the coexistence between different RATs, e.g., the coexistence between LTE and NR in licensed and/or unlicensed spectrum or licensing light spectrum (e.g., LAA or LSA), or the coexistence between NR and WiFi, etc., and thus improve the overall co-channel coexistence including the overall system performance of sidelink operation wrt. throughput, latency and/or reliability. Furthermore, the term unlicensed can refer to bands that are not owned or licensed by a single entity or operator but are restricted for usage for a certain purpose, e.g., spectrum for designated use for the intelligent transport systems (ITS) (see, e.g., 5GAA Position Paper “Coexistence of C-V2X and ITS-G5 at 5.9 GHz”, 5 Apr. 2018, https://5gaa.org/news/position-paper-coexistence-of-c-v2x-and-802-11p-at-5-9-ghz/). These bands can be shared by different RATs and/or transmission technologies and/or operators, e.g., in the above case, C-V2X and ITS-5G, with the underlying access technologies LTE sidelink and/or NR sidelink and/or IEEE 802.11p.

The present invention addresses this need by providing different aspects for improving or enhancing a sidelink communication making use of the unlicensed spectrum, for example for assisting a base station or gNB with the resource allocation for a sidelink communication between two or more UEs in an unlicensed spectrum.

### First Aspect

In accordance with a first aspect, the present invention provides an approach by which a sidelink, SL, UE that operates, at least partially, in the unlicensed spectrum for performing sidelink communication provides to a serving base station or gNB occupancy information regarding the unlicensed spectrum. The SL-UE may be configured with a first sidelink resource pool, SL-RP, including at least some resources in the unlicensed spectrum and, for at least these resources, the SL-UE provides occupancy information to the gNB.

In accordance with embodiments of the first aspect, the occupancy information may be information directly indicating whether one or more or all resources in the unlicensed spectrum, like the resources in the first SL-RP, are currently used or occupied. For example, a UE, like a SL-UE, may provide measurement reports to the base station or gNB for providing a resource occupancy status report informing the gNB whether a certain resource, for example a certain resource within a resource pool used for the sidelink communication in the unlicensed spectrum, is occupied or not.

In accordance with other embodiments of the first aspect, the occupancy information may be information indicating use of the unlicensed spectrum, like the resources in the first SL-RP. For example, a SL-UE may provide an occupancy status report to the base station or gNB which, instead of reporting an exact occupancy map for the resources of the SL-RP, indicates how or by what entities the unlicensed spectrum is currently used. In other words, by means of the occupancy status report the SL-UE provides certain information about the unlicensed band, e.g., a user, a detected cast-type within the unlicensed band, or a synchronization preamble detected in the unlicensed band, and the like.

### Second Aspect

In accordance with a second aspect, the present invention provides an approach by which a SL-UE, which performs a sidelink communication using at least in part resources in the unlicensed spectrum, may decide to request such resources for a transmission in the unlicensed band, for example in a first sidelink resource pool, SL-RP, including at least some resources in an unlicensed band, only in case one or more criteria are fulfilled or given.

Embodiments of the second aspect do not rely on the base station or gNB to provide actually unoccupied resources, rather, the SL-UE itself may use measurement reports to decide whether a resource or resource pool may be used or not. In other words, only in case the UE determines that certain resources, which the gNB may allocate in the unlicensed spectrum, are actually available, the UE requests from the gNB an allocation of such resources for the sidelink communication.

### Third Aspect

In accordance with a third aspect, the present invention provides an approach by which the SL-UE is provided with a resource allocation indicating different sets of resources in the licensed and/or unlicensed band for a transmission to be performed over the sidelink, and the UE may determine which of the received sets of resources to use for the transmission, for example to use only the set of resources for a transmission which the UE judges to be not occupied.

In conventional approaches, but also when considering the first and second aspects of the present invention mentioned above, when the SL-UE receives a grant from a gNB, it may not blindly assume that the resource is unoccupied, since, especially in the unlicensed spectrum, any other device using the same RAT or using another RAT may already access or use the resource. This is addressed by the third aspect which, in accordance with embodiments, provides an approach by the UE checks whether a granted resource is actually available or not, for example by implementing a concept of multiple resource selections across different frequency bands, each being classified as either a primary band, a secondary band and so on so that the SL-UE may step through the respective bands when looking for non-occupied resources.

### Fourth Aspect

In accordance with a fourth aspect, the present invention provides an approach by which a SL-UE receives multiple grants for a transmission in the unlicensed spectrum and indicates for each grant whether it was actually used or not for the transmission.

Embodiments of the fourth aspect explore how a SL-UE may manage multiple grants received from the gNB so that used grants/resources may be used otherwise.

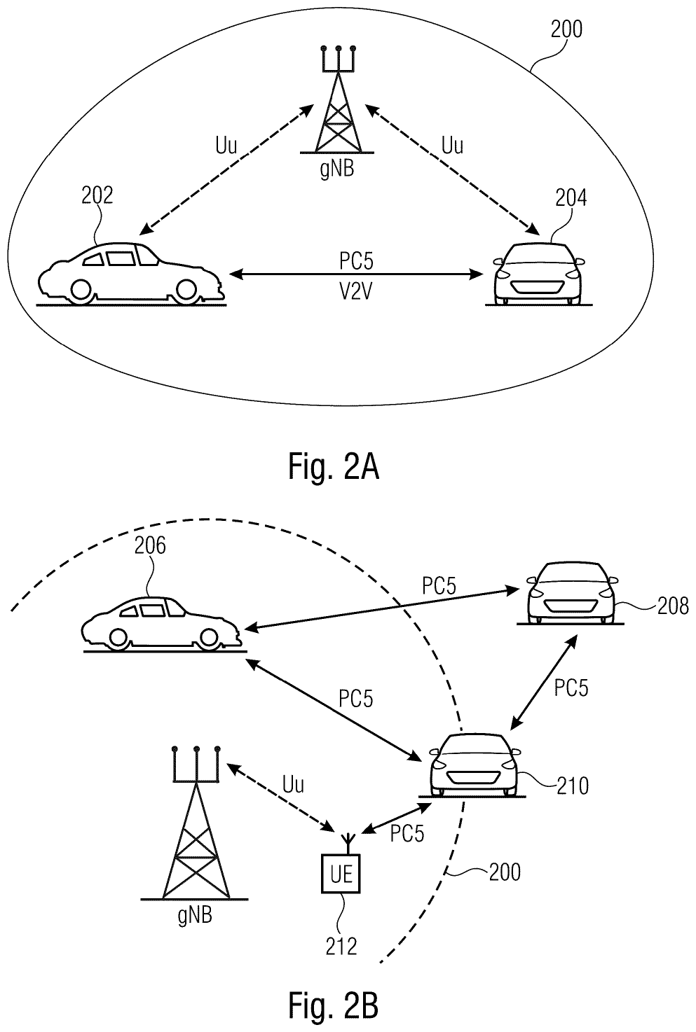

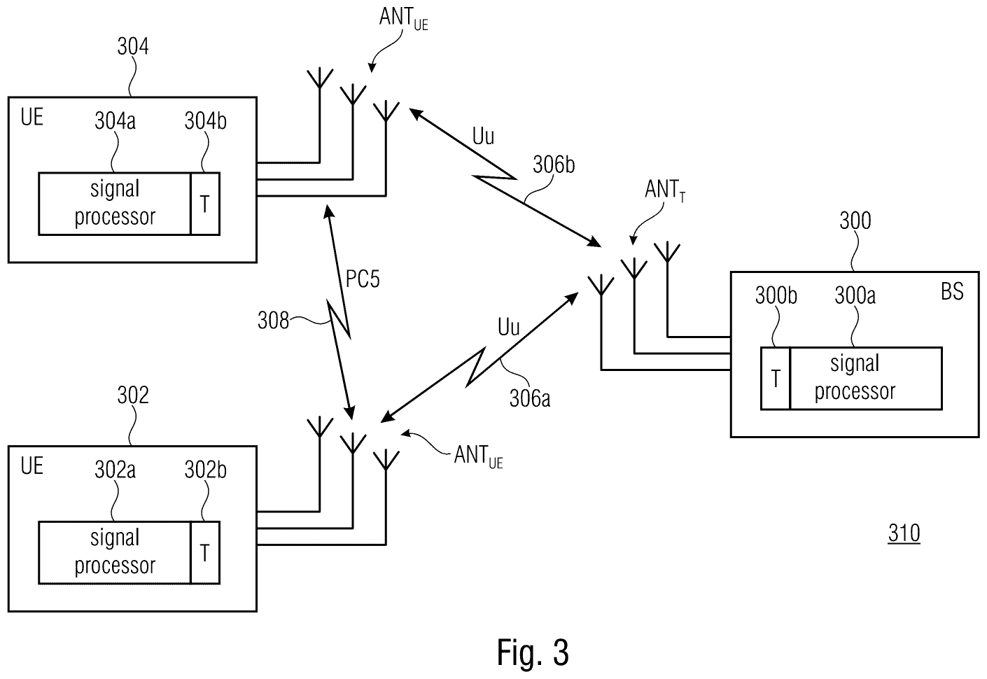

Embodiments of the present invention may be implemented in a wireless communication system as depicted in FIG. 1A, FIG. 2A or FIG. 2B including base stations and users, like mobile terminals or IoT devices. FIG. 3 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 3, the one or more UEs 302, 304 of FIG. 3, and the base station 300 of FIG. 3 may operate in accordance with the inventive teachings described herein.

### 1^{st} Aspect

### SL UE

The present invention provides a user device, UE, for a wireless communication system, like a 3^{rd} Generation Partnership Project, 3GPP, system,
wherein the UE is to communicate using a sidelink, SL, using resources allocated by a base station of the wireless communication system,
wherein the UE is configured or preconfigured with at least one first SL resource pool including resources in an unlicensed spectrum, and
wherein the UE is to provide to the base station occupancy information regarding the unlicensed spectrum.

In accordance with embodiments,
the occupancy information is information directly indicating whether one or more or all resources in the unlicensed spectrum, like the resources in the first SL-RP, are used or occupied, or
the occupancy information is information indicating use of the unlicensed spectrum, like the resources in the first SL-RP.

In accordance with embodiments, the first SL resource pool only contains resources in the unlicensed spectrum.

In accordance with embodiments, the first SL resource pool contains resources in a licensed spectrum and in the unlicensed spectrum.

In accordance with embodiments, the resources in the unlicensed spectrum are aggregated using carrier aggregation.

In accordance with embodiments, the UE is to obtain the occupancy information for the one or more or all resources of the first SL resource pool, or only for resources of the first SL resource pool which are in the unlicensed spectrum.

In accordance with embodiments, to obtain the occupancy information for a resource, the UE is to carry out one or more to the following:
perform a Listen-Before-Talk, LBT, on or immediately before the resource,
detect one or more energy levels on the resource, e.g., a Received Signal Strength Indication, RSSI, a Signal to Noise Ratio, SNR, or a Signal to Noise Interference Ratio, SINR,
measure pilot symbols transmitted on the resource and/or determine one or more measured values, e.g., a 3GPP Reference Signal Receive Power, RSRP, or a 3GPP Reference Signal Received Quality, RSRQ,
decode a sidelink assistance information message, AIM,
decode control messages transmitted on the resource, e.g., 3GPP sidelink control information, SCI, or a 802.11 Physical Layer Convergence Protocol, PLCP, header, and extract information on one or more transmissions, like ongoing or upcoming transmissions or a remaining duration of an ongoing transmission.

In accordance with embodiments, based on the obtained occupancy information for a resource, the UE is to determine a measured or occupancy value, which is used to determine whether a resource is occupied, unavailable or busy.

In accordance with embodiments, the UE is to determine a resource of the first SL resource pool, which is used by a 3GPP system, to be occupied, unavailable or busy in case:
an average of the determined measured or occupancy value over the entire resource exceeds a configured or preconfigured threshold, or
any determined measured or occupancy value for the resource exceeds the threshold, or
consecutive or non-consecutive determined measured or occupancy values for the resource exceed the threshold at least for a configured or preconfigured duration, or
one measured or occupancy value, or a set of measured or occupancy values, or all measured or occupancy values for the resource exceed the threshold, or
a decoded control message indicates an ongoing or upcoming transmission using the resource.

In accordance with embodiments, the UE is to determine a resource of the first SL resource pool, which is used by a non-3GPP system, to be occupied, unavailable or busy in case:
an average of the detected energy level over the entire resource exceeds a configured or preconfigured energy detection threshold, or
any detected energy level for the resource exceeds the energy detection threshold, or
consecutive or non-consecutive detected energy levels for the resource exceed the energy detection threshold at least for a configured or preconfigured duration, or
a set of detected energy levels for the resource exceeds the energy detection threshold, or
all detected energy levels for the resource exceed the energy detection threshold, or
a decoded control message indicates an ongoing or upcoming transmission using the resource, or
a preamble is detected which indicates an ongoing or upcoming transmission.

In accordance with embodiments, the UE is to provide to the base station a report including the occupancy information, wherein the report comprises one or more of the following:
a report indicating for some or all of the resources of the first SL resource pool information obtained from the resources, e.g., the detected energy levels or the determined measured or occupancy values, or the decoded control information,
a report indicating for some or all of the resources of the first SL resource pool an occupancy status, e.g., a congestion indication, like a single bit or a certain value, per resource whether the resource is occupied or not,
a report indicating for the entire first SL resource pool an occupancy status, e.g., a percentage at which the first SL resource pool is occupied or a percentage at which the first SL resource pool is non-occupied,
a report indicating one or more occupancy statuses, e.g., a percentage at which the unlicensed resources belonging to a certain LBT sub-band are occupied.

In accordance with embodiments, the report indicates the occupancy information with one or more of the following granularities:
a physical layer, PHY, based granularity, e.g., by using a time resource indicator value, TRIV, of a frequency resource indicator value, FRIV, or a bitmap,
a subchannel granularity or a group of subchannel granularity,
a resource pool granularity.

In accordance with embodiments, the report indicates the occupancy status for one or more of the following:
a single time entity and/or frequency entity of the first SL resource pool, like a Resource Block, RB,
a group of RBs of the first SL resource pool,
a subchannel of the first SL resource pool,
a group of contiguous or non-contiguous subchannels of the first SL resource pool,
a time slot of the first SL resource pool,
a group of continuous or discontinuous time slots of the first SL resource pool.

In accordance with embodiments, the UE is to provide
a report indicating an occupancy status for resources used by a 3GPP system only, like a LTE-only report or an NR-only report, or
a report indicating an occupancy status for resources used by a non-3GPP system only, like a non-3GPP-RAT report, or
a report indicating an occupancy status for resources used by a 3GPP system and used by a non-3GPP system.

In accordance with embodiments, the UE is to transmit the report to the base station
responsive to a request from a core network, CN, entity, or from a base station or from a road side unit, RSU, or from another UE, or
responsive to on one or more triggers configured or preconfigured triggers, or
periodically or semi-statically in accordance with a configuration or a or preconfiguration.

In accordance with embodiments, the trigger comprises one or more of:
a change in measurement values by a configured or preconfigured threshold, e.g., a certain change in the Channel Busy Ratio, CBR, or in the Signal to Interference and Noise Ratio, SINR,
one or more measurement values exceeding a configured or preconfigured threshold,
one or more LBT failures,
sending of a scheduling request or a Buffer Status Report, BSR,
a number of Hybrid Automatic Repeat Request, HARQ, Non-Acknowledgements, NACKs,
a feedback received via a feedback channel, like the physical sidelink feedback channel, PSFCH, e.g., a collision indicator, CI, detailing about past or potential future collisions,
   a received assistance information message, AIM, or an inter-UE coordination, IUC, message send by another UE or RSU,
lapse of a configured or preconfigured timer.

In accordance with embodiments, the occupancy information is one or more of
a Channel Busy Ratio, CBR,
a congestion indication, e.g., a number of Physical Channel Identifiers, PCIDs, seen, or a number of UE IDs detected,
a radio resource map of some or all occupied and/or free resources, subbands, resource pools, BWPs, component carriers,
a minimum or maximum or average or predicted channel access time, e.g., how long the UE has to contend for channel access, e.g., using LBT
a simple indication, e.g., using a 1-bit field, indicating that there is activity in the subband or RP,
an indirect indication, e.g., by only indicating the congestion status for a subband, which is indicative for the usage of a whole set of subbands, RPs or carrier.

In accordance with embodiments, the occupancy information includes one or more of the following:
an operator using the unlicensed spectrum, e.g., in case the unlicensed spectrum is used by an operator using a 3GPP-like technology and being different from the operator of the wireless communication system of the given UE,.
a physical cell ID (PCID), e.g., linked to the resources used in the unlicensed spectrum,
any other type of cell identifier, e.g., a WiFi SSID or a Bluetooth or BLE identifier,
a radio access technology, RAT, using the resources, e.g., a 3GPP RAT or a non-3GPP RAT, like WiFi, Bluetooth or Bluetooth Low Energy, BLE,
a resource pool ID of a different 3GPP wireless communication system,
a geolocation of the UE, e.g., based on zones or exact location coordinates or any other type of distance measure, e.g., indicating the distance between gNB und UE or between UE and a potential user of the unlicensed spectrum,
a source ID and/or a destination IDs of a further UE using the occupied resources,.
an indication of usage of unlicensed resources by the UE itself and/or details on the usage, e.g., WiFi hotspot, Bluetooth audio connection, Bluetooth data connection, BLE, etc.,
any information on the type of traffic transmitted on the resources in the unlicensed spectrum, e.g., a cast-type, or a QoS-class,
information on the congestion status, e.g., a congestion flag, of the resources in the unlicensed spectrum,
information on the resource usage of a 2^{nd} unlicensed spectrum that it currently is not configured to be used by the said UE, but which is monitored by the said UE anyways,
channel state information, CSI, or other information required for beam management or beam steering.

In accordance with embodiments, a resource of the first SL resource pool comprises one or more of the following:
one or more symbols,
one or more time slots or subframes or frames,
one or more frequencies or carriers or subchannels or group of subchannels,
one or more frequency bands, like unlicensed subbands,
one or more bandwidth parts,
one or more resource pools.

### gNB

The present invention provides a base station for a wireless communication system, like a 3^{rd} Generation Partnership Project, 3GPP, system, the wireless communication system comprising a plurality of sidelink user devices, SL-UEs, communicating using a sidelink, SL,
wherein the base station is to allocate to a SL-UE, for a communication using the SL, one or more resources from at least one first SL resource pool, the at least one first SL resource pool including resources in an unlicensed spectrum, and
wherein the base station is to receive occupancy information for one or more or all resources of the first SL resource pool, and is to select resources to be allocated to the SL-UE from the first SL pool dependent on the received occupancy information.

In accordance with embodiments, the base station is to receive a report from the SL-UE including the occupancy information, wherein the report comprises one or more of the following:
a report indicating for some or all of the resources of the first SL resource pool information obtained from the resources, e.g., the detected energy levels or the determined measured or occupancy values, or the decoded control information,.
a report indicating for some or all of the resources of the first SL resource pool an occupancy status, e.g., a congestion indication, like a single bit or a certain value, per resource whether the resource is occupied or not,
a report indicating for the entire first SL resource pool an occupancy status, e.g., a percentage at which the first SL resource pool is occupied or a percentage at which the first SL resource pool is non-occupied.

In accordance with embodiments, the report indicates the occupancy status for one or more of the following:
a single time entity and/or frequency entity of the first SL resource pool, like a Resource Block, RB,
a group of RBs of the first SL resource pool,
a subchannel of the first SL resource pool,
a group of contiguous or non-contiguous subchannels of the first SL resource pool,
a time slot of the first SL resource pool,
a group of continuous or discontinuous time slots of the first SL resource pool.

In accordance with embodiments, when receiving a report indicating for some or all of the resources of the first SL resource pool information obtained from the resources, the base station is to determine for some or all of the resources of the first SL resource pool or for the entire first SL resource pool an occupancy status.

In accordance with embodiments, the base station is to select resources to be allocated to the SL-UE from the first SL pool dependent on the received or determined occupancy status.

In accordance with embodiments, the base station is to select a resource pool for a SL-UE or reconfigure a SL-UE, e.g., trigger a handover, dependent on the received or determined occupancy status of the resource pool.

In accordance with embodiments, the base station is to request from the SL-UE the report.

### 2^{nd} Aspect

### SL UE

The present invention provides a user device, UE, for a wireless communication system, like a 3^{rd} Generation Partnership Project, 3GPP, system,
wherein the UE is to communicate using a sidelink, SL, using resources allocated by a base station of the wireless communication system,
wherein the UE is configured or preconfigured with at least one first SL resource pool including resources in an unlicensed spectrum, and
wherein the UE is to request from the base station, directly or via another UE, one or more resources for a transmission in the first SL resource pool dependent on one or more criteria.

In accordance with embodiments, the first SL resource pool only contains resources in the unlicensed spectrum.

In accordance with embodiments, the first SL resource pool contains resources in a licensed spectrum and in the unlicensed spectrum.

In accordance with embodiments, the one or more criteria comprise one or more of the following:
an occupancy status of the first SL resource pool,
a Buffer Status Report, BSR, indicating that a buffer of the UE holds data,
an upcoming Ultra Reliable Low Latency Communication, URLLC, transmission, e.g., a need to transmit delay critical data,
a grant type used on a carrier in a licensed spectrum, e.g., in case the UE is to operate with configured grants, like Type1 or Type2, or SPS-like, but a quota exceeds that of a configuration,
a Hybrid Automatic Repeat Request, HARQ, status, e.g., in case a number of HARQ failures or HARQ Non-Acknowledgements, NACKs, exceeds a threshold.
a status on resource collisions, e.g., like a collision indicator, CI, based on past or potential future collisions,
any other data received via the physical sidelink feedback channel, PSFCH,
data duplication is enabled,
one or more properties of the transmission, like message type, priority, message size,
a number of previously failed Listen-Before-Talk, LBTs, or failed resource access attempts on one or more or all resources of the first SL resource pool,
a mobility status of the UE,
a minimum required communication range of the UE,
a geolocation of the UE, e.g., based on zones or exact location coordinates or any other type of distance measure, e.g., indicating the distance between gNB und UE or between UE and a potential user of the unlicensed spectrum,
an assistance information message, AIM, or an inter-UE coordination, IUC, message received by another UE, e.g., the AIM containing a set of preferred or non-preferred resources.

In accordance with embodiments, the UE is to request resources in the first SL resource pool in case the occupancy status of the first SL resource pool is below a configured or preconfigured threshold.

In accordance with embodiments, the UE is to determine the occupancy status of the first SL resource pool using one or more of the following properties:
detected energy levels on some or all of the resources of the first SL resource pool, e.g., a Received Signal Strength Indication, RSSI, a Signal to Noise Ratio, SNR, or a Signal to Noise Interference Ratio, SINR,
measured values, e.g., a 3GPP Reference Signal Receive Power, RSRP, or a 3GPP Reference Signal Received Quality, RSRQ, determined using measured pilot symbols transmitted on some or all of the resources of the first SL resource pool,
a number of decoded control messages transmitted on some or all of the resources of the first SL resource pool, e.g., 3GPP sidelink control information, SCI, or a 802.11 Physical Layer Convergence Protocol, PLCP, header, and including information on one or more transmissions, like ongoing or upcoming transmissions, e.g., by evaluating a network allocation vector, NAV, or a remaining duration of an ongoing transmission.

In accordance with embodiments, the UE is to determine the first SL resource pool to be congested in case:
an average of the one or more properties over the entire first SL resource pool exceeds a configured or preconfigured threshold, or
the one or more properties exceed the configured or preconfigured threshold for one, some or all resources of the first SL resource pool.

In accordance with embodiments, the UE is to request resources in the first SL resource pool in case the transmission has one or more configured or preconfigured properties.

In accordance with embodiments, the property of the transmission includes one or more of the following:
a transmission type,
a transmission size,
a transmission contents, e.g., a message used for resource coordination among UEs communicating using the SL, like an assistance information message, AIM, or feedback information such as channel state information (CSI) to be transmitted by the said UE,
a priority,
a cast type of the transmission,
whether a feedback is required, like a Hybrid Acknowledge Request, HARQ, feedback.

In accordance with embodiments, the UE is to request resources in the first SL resource pool in case the number of previously failed LBTs or failed resource access attempts is below a configured or preconfigured threshold.

In accordance with embodiments, the UE is to request resources in the first SL resource pool in case the mobility status of the UE indicates that the UE moves with a speed that is below a configured or preconfigured threshold.

In accordance with embodiments, the UE is to request resources in the first SL resource pool in case a recipient UE, which is to receive the transmission using the SL, is within the minimum required communication range of the UE.

In accordance with embodiments, the UE is to request resources in the first SL resource pool in case the geolocation of the UE indicates an area in which a probability for a disturbance of the transmission, like an interference with another transmission, is below a configured or preconfigured threshold.

In accordance with embodiments, the UE is to request the resources for the transmission using a logical channel associated with the first SL resource pool.

In accordance with embodiments, the UE is configured or preconfigured with at least one second SL resource pool including resources in a licensed spectrum, and is to request from the base station the one or more resources for the transmission in the first SL resource pool or in the second SL resource pool dependent on the one or more criteria.

In accordance with embodiments, the UE is to request the resources for the transmission using a logical channel associated with the first SL resource pool or the second SL resource pool.

In accordance with embodiments, a resource of the first SL resource pool comprises one or more of the following:
one or more symbols,
one or more time slots or subframes or frames,
one or more frequencies or carriers,
one or more frequency bands, like unlicensed subbands.

### gNB

The present invention provides a base station for a wireless communication system, like a 3^{rd} Generation Partnership Project, 3GPP, system, the wireless communication system comprising a plurality of sidelink user devices, SL-UEs, communicating using a sidelink, SL,
wherein the base station is to allocate to a SL-UE, for a communication using the SL, one or more resources from at least one first SL resource pool or from at least one second SL resource pool, the at least one first SL resource pool including resources in an unlicensed spectrum, and the at least one second SL resource pool including resources in a licensed spectrum,
wherein the base station is to receive from a SL UE a request, like a Buffer Status Report, BSR, for one or more resources for a transmission, and
wherein the request is received on a logical channel linked to one of the first or second resource pools, and the base station is to allocate resources for the transmission from the resource pool.

In accordance with embodiments, the scheduled resources are linked to the logical channel on which the request was received.

In accordance with embodiments, responsive to the request and prior to allocating any resources, the base station is to trigger the SL-UE to provide an occupancy report indicating an occupancy status for one or more or all resources of the first SL resource pool.

In accordance with embodiments, based on the occupancy report, the base station is to allocate resources or provide resource grants in only in the unlicensed spectrum, or only in the licensed spectrum, or both in the unlicensed spectrum and in the licensed spectrum.

### 3^{rd} Aspect

### SL UE

The present invention provides a user device, UE, for a wireless communication system, like a 3^{rd} Generation Partnership Project, 3GPP, system,
wherein the UE is to communicate using a sidelink, SL, using resources allocated by a base station of the wireless communication system,
wherein the UE is configured or preconfigured with at least one first SL resource pool and with at least one second SL resource pool,
wherein the UE is to receive from the base station, directly or via another UE, a resource allocation for a transmission using the SL, the resource allocation comprising a plurality of sets of resources from one or more of the first and second SL resource pools, each set of resources available for the UE to carry out the transmission or to be signaled to a further UE as resources available or not available or as a preferred or non-preferred set of resources to be used for a transmission by the further UE, e.g., using an assistance information message, AIM, and
wherein the UE is to determine among the plurality of sets of resources an unoccupied set of resources and to carry out the transmission using the unoccupied set of resources or to signal to the further UE the unoccupied set of resources as the available resources.

In accordance with embodiments,
the first SL resource pool comprises:
   only resources in a licensed spectrum, or
   only resources in an unlicensed spectrum, or
   resources both in the licensed spectrum and in the unlicensed spectrum, and
the second SL resource pool comprises:
   only resources in the licensed spectrum, or
   only resources in the unlicensed spectrum, or
   resources both in the licensed spectrum and in the unlicensed spectrum.

In accordance with embodiments, the UE is to
(a) select from the plurality of sets of resources a current set of resources,
(b) evaluate whether the current set of resources is occupied or unoccupied,
(c) in case the current set of resources in unoccupied, use the current set of resources for the transmission,
(d) in case the current set of resources is occupied, select from the plurality of sets of resources another, not yet evaluated set of resources as the current set of resources and repeat operations (a) to (d).

In accordance with embodiments,.
the first SL resource pool includes resources only in the unlicensed spectrum,
the second SL resource pool includes resources only in the licensed spectrum,
the resource allocation comprises one or more sets of resources in the first SL resource pool and in the second SL resource pool, and
in case none of the sets of resources in the first SL resource pool is unoccupied, the UE is to use for the transmission the set of resources in the second SL resource pool.

In accordance with embodiments, the allocation of the plurality of sets of resources in the first and second SL resource pools, e.g., in a Downlink Control Information, DCI, or in a MAC CE or RRC or by higher layer signaling, includes:
multiple time resource indicator values, TRIVs, and/or multiple frequency resource indicator values, FRIVs, or
a bitmap across time, the bitmap indicating resources, like OFDM symbols or time slots or subframes or frames, where the resource set is defined as spanning either a portion or the entire length of the one BWP, or
a bitmap across frequency, the bitmap indicating resources, like resource blocks, across the one BWP, or
a starting resource in time, like a time slot or a subframe, and a duration of the resource set, or
a starting resource in frequency, like a resource block, and a number of resources for a resource set, or
multiple starting resources, like resource blocks, and ending resources, if the resource set is non-contiguous over frequency, or
explicit resources numbers, like time slot or subframe numbers or explicit resource indices, like resource block indices, or
punctured out resources mentioned explicitly or that are part of another set of resources or RP, or
a starting resource, and periodic offsets for subsequent occurrences, or
a pattern in time, defined by symbols, time slots or subframes or frames, and/or in frequency, defined by resource blocks, subchannels or sub bands,
one or more RRC configured transmission pattern for a number of transmissions.

In accordance with embodiments, a set of resources of the first SL resource pool comprises one or more of the following:
one or more symbols,
one or more time slots or subframes or frames,
one or more LBT sub-bands,
one or more frequencies or carriers,
one or more frequency bands, like unlicensed subbands
one or more spatial resources, e.g., using spatial multiplexing.

### gNB

The present invention provides a base station for a wireless communication system, like a 3^{rd} Generation Partnership Project, 3GPP, system, the wireless communication system comprising a plurality of sidelink user devices, SL-UEs, communicating using a sidelink, SL,
wherein the base station is to provide to a SL UE, directly or via another UE, a resource allocation for a transmission by the SL UE using the SL, the resource allocation comprising a plurality of sets of resources from at least one first SL resource pool and/or from at least one second SL resource pool, each set of resources available for the UE to carry out the transmission or to be signaled to a further UE as resources available for a transmission by the further UE, e.g., using an assistance information message, AIM.

In accordance with embodiments,
wherein the first SL resource pool comprises:
   only resources in a licensed spectrum, or
   only resources in an unlicensed spectrum, or
   resources both in the licensed spectrum and in the unlicensed spectrum, and
wherein the second SL resource pool comprises:
   only resources in the licensed spectrum, or
   only resources in the unlicensed spectrum, or
   resources both in the licensed spectrum and in the unlicensed spectrum.

In accordance with embodiments, the allocation of the plurality of sets of resources in the first and second SL resource pools, e.g., in a Downlink Control Information, DCI, or in a MAC CE or via RRC or by higher layer signaling, includes:
multiple time resource indicator values, TRIVs, and/or multiple frequency resource indicator values, FRIVs, or
a bitmap across time, the bitmap indicating resources, like OFDM symbols or time slots or subframes or frames, where the resource set is defined as spanning either a portion or the entire length of the one BWP, or
a bitmap across frequency, the bitmap indicating resources, like resource blocks, across the one BWP, or
a starting resource in time, like a time slot or a subframe, and a duration of the resource set, or
a starting resource in frequency, like a resource block, and a number of resources for a resource set, or
multiple starting resources, like resource blocks, and ending resources, if the resource set is non-contiguous over frequency, or
explicit resources numbers, like time slot or subframe numbers or explicit resource indices, like resource block indices, or
punctured out resources mentioned explicitly or that are part of another set of resources or RP, or
a starting resource, and periodic offsets for subsequent occurrences, or
a pattern in time, defined by symbols, time slots or subframes or frames, and/or in frequency, defined by resource blocks, subchannels or sub bands,
one or more RRC configured transmission pattern for a number of transmissions.

### 4^{th} Aspect

### SL UE

The present invention provides a user device, UE, for a wireless communication system, like a 3^{rd} Generation Partnership Project, 3GPP, system,
wherein the UE is to communicate using a sidelink, SL, using resources allocated by a base station of the wireless communication system,
wherein the UE is configured or preconfigured with at least one first SL resource pool including resources in an unlicensed spectrum,
wherein the UE is to receive from the base station, directly or via another UE, a plurality of grants, like via a Downlink Control Information, DCI, when received from the base station or via sidelink control information, SCI, when received via the other UE, for a certain transmission using the SL, each of the plurality of grants comprising one or more SL resources, and
wherein the UE is to indicate for a grant whether the grant or resources within the grant are to be used or were used for the certain transmission.

In accordance with embodiments, the UE is to indicate
for all of the grants whether they were used, or
that one of the grants was used, or
which one of the grants was used, or
for a subset of grants, which grants where used.

In accordance with embodiments, the UE is to receive a further grant from the gNB or from another UE depending on the previous report of used grants.

In accordance with embodiments, the further grants received are on or more of the following:
a configured grant type 1,
a configured grant type 2,
a dynamic grant,
a sidelink AIM, e.g., from another UE or GL-UE.

In accordance with embodiments, the UE is to send a feedback to the base station, and wherein a feedback indicating that a grant was not used causes the base station to release some or all of the remaining grants of the plurality of grants.

In accordance with embodiments, the UE is to send to another UE, e.g., via a sidelink assistance information message, SL AIM, an indication of a usage of the plurality of grants.

In accordance with embodiments, an indication that a grant was not used causes the other UE to
use some or all of the remaining grants of the plurality of grants for a transmission by the other UE or
forwards a grant on the resources of some or all of the remaining grants to a third UE.

In accordance with embodiments, the feedback is piggybacked with another control message, e.g., a buffer status report, BSR, or an occupancy status report for the first SL resource pool.

In accordance with embodiments, responsive to an indication that a grant was not used, the UE is to use some or all of the remaining grants of the plurality of grants for retransmitting the certain transmission or for another transmission by the UE.

In accordance with embodiments, retransmitting the certain transmission comprises
a redundancy transmission, e.g., duplicating the certain transmission and sending it several times, like a certain transmission including a warning message or an alert message, or
providing several redundancy versions and sending them at several times, or
using the additional resource to transmit a feedback information message, e.g., on the Physical sidelink feedback channel, PSFCH, or an occupancy status report to the base station.

In accordance with embodiments, for retransmitting the certain transmission, the UE is to change a modulation and coding scheme, MCS, or switch from a beamformer currently used for the certain transmission to a new beamformer.

In accordance with embodiments, in case the certain transmission is not completed using all of the plurality of grants, the UE is to request one or more further grants from the base station.

In accordance with embodiments, a SL resource of the first SL resource pool comprises one or more of the following:
one or more symbols,
one or more time slots or subframes or frames,
one or more frequencies or carriers,
one or more frequency bands or groups of frequencies or subchannels, like unlicensed subbands.

### gNB

The present invention provides a base station for a wireless communication system, like a 3^{rd} Generation Partnership Project, 3GPP, system, the wireless communication system comprising a plurality of sidelink user devices, SL-UEs, communicating using a sidelink, SL,
wherein the base station is to provide to a SL UE, directly or via another UE, a plurality of grants, like via a Downlink Control Information, DCI, when received from the base station or via a sidelink control information, SCI, when received via the other UE, for a certain transmission by the SL UE using the SL, each of the plurality of grants comprising one or more SL resources from at least one first SL resource pool including resources in an unlicensed spectrum, and
wherein the base station is to receive from the SL UE a feedback for each grant which indicates whether the grant was used for the certain transmission.

In accordance with embodiments, responsive to a feedback indicating that a grant was not used, the bases station is to release some or all of the remaining grants of the plurality of grants so as to allow using the resources thereof to be allocated for other transmissions by the SL UE or by another SL UE.

### System

The present invention provides a wireless communication system, like a 3^{rd} Generation Partnership Project, 3GPP, system, comprising a one or more user devices, UEs, of any one of the preceding claims and/or one or more base stations of any one of the preceding claims.

In accordance with embodiments, the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a SL UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments, the base station comprises one or more of a macro cell base station, or a small cell base station, or a central unit of a base station, or a distributed unit of a base station, or an Integrated Access and Backhaul, IAB, node, or a road side unit, RSU, or a UE, or a SL UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

### Methods

The present invention provides a method for operating a user device, UE, for a wireless communication system, like a 3^{rd} Generation Partnership Project, 3GPP, system, wherein the UE is to communicate using a sidelink, SL, using resources allocated by a base station of the wireless communication system, and wherein the UE is configured or preconfigured with at least one first SL resource pool including resources in an unlicensed spectrum, the method comprising:
providing to the base station occupancy information regarding the unlicensed spectrum.

The present invention provides a method for operating a base station for a wireless communication system, like a 3^{rd} Generation Partnership Project, 3GPP, system, the wireless communication system comprising a plurality of sidelink user devices, SL-UEs, communicating using a sidelink, SL, the method comprising:
allocating to a SL-UE, for a communication using the SL, one or more resources from at least one first SL resource pool, the at least one first SL resource pool including resources in an unlicensed spectrum,
receiving occupancy information for one or more or all resources of the first SL resource pool, and
selecting resources to be allocated to the SL-UE from the first SL pool dependent on the received occupancy information.

The present invention provides a method for operating a method for operating a user device, UE, for a wireless communication system, like a 3^{rd} Generation Partnership Project, 3GPP, system, wherein the UE is to communicate using a sidelink, SL, using resources allocated by a base station of the wireless communication system, and wherein the UE is configured or preconfigured with at least one first SL resource pool including resources in an unlicensed spectrum, the method comprising:
requesting from the base station, directly or via another UE, one or more resources for a transmission in the first SL resource pool dependent on one or more criteria.

The present invention provides a base station for a wireless communication system, like a 3^{rd} Generation Partnership Project, 3GPP, system, the wireless communication system comprising a plurality of sidelink user devices, SL-UEs, communicating using a sidelink, SL, the method comprising:
allocating to a SL-UE, for a communication using the SL, one or more resources from at least one first SL resource pool or from at least one second SL resource pool, the at least one first SL resource pool including resources in an unlicensed spectrum, and the at least one second SL resource pool including resources in a licensed spectrum,
receiving from a SL UE a request, like a Buffer Status Report, BSR, for one or more resources for a transmission, wherein the request is received on a logical channel linked to one of the first or second resource pools, and
allocating resources for the transmission from the resource pool.

The present invention provides a method for operating a method for operating a user device, UE, for a wireless communication system, like a 3^{rd} Generation Partnership Project, 3GPP, system, wherein the UE is to communicate using a sidelink, SL, using resources allocated by a base station of the wireless communication system, and wherein the UE is configured or preconfigured with at least one first SL resource pool and with at least one second SL resource pool, the method comprising:
receiving from the base station, directly or via another UE, a resource allocation for a transmission using the SL, the resource allocation comprising a plurality of sets of resources from one or more of the first and second SL resource pools, each set of resources available for the UE to carry out the transmission or to be signaled to a further UE as resources available or not available or as a preferred or non-preferred set of resources to be used for a transmission by the further UE, e.g., using an assistance information message, AIM, and
determining among the plurality of sets of resources an unoccupied set of resources and to carry out the transmission using the unoccupied set of resources or to signal to the further UE the unoccupied set of resources as the available resources.

The present invention provides a method for operating a base station for a wireless communication system, like a 3rd Generation Partnership Project, 3GPP, system, the wireless communication system comprising a plurality of sidelink user devices, SL-UEs, communicating using a sidelink, SL, the method comprising:
providing to a SL UE, directly or via another UE, a resource allocation for a transmission by the SL UE using the SL, the resource allocation comprising a plurality of sets of resources from at least one first SL resource pool and/or from at least one second SL resource pool, each set of resources available for the UE to carry out the transmission or to be signaled to a further UE as resources available for a transmission by the further UE, e.g., using an assistance information message, AIM.

The present invention provides a method for operating a user device, UE, for a wireless communication system, like a 3rd Generation Partnership Project, 3GPP, system, wherein the UE is to communicate using a sidelink, SL, using resources allocated by a base station of the wireless communication system, and wherein the UE is configured or preconfigured with at least one first SL resource pool including resources in an unlicensed spectrum, the method comprising:
receiving from the base station, directly or via another UE, a plurality of grants, like via a Downlink Control Information, DCI, when received from the base station or via sidelink control information, SCI, when received via the other UE, for a certain transmission using the SL, each of the plurality of grants comprising one or more SL resources, and
indicating for a grant whether the grant or resources within the grant are to be used or were used for the certain transmission.

The present invention provides a method for operating a base station for a wireless communication system, like a 3^{rd} Generation Partnership Project, 3GPP, system, the wireless communication system comprising a plurality of sidelink user devices, SL-UEs, communicating using a sidelink, SL, the method comprising:
providing to a SL UE, directly or via another UE, a plurality of grants, like via a Downlink Control Information, DCI, when received from the base station or via a sidelink control information, SCI, when received via the other UE, for a certain transmission by the SL UE using the SL, each of the plurality of grants comprising one or more SL resources from at least one first SL resource pool including resources in an unlicensed spectrum, and
receiving from the SL UE a feedback for each grant which indicates whether the grant was used for the certain transmission.

### Computer Program Product

Embodiments of the first aspect of the present invention provide a computer program product comprising instructions which, when the program is executed by a computer, causes the computer to carry out one or more methods in accordance with the present invention.

Embodiments of the inventive aspect are now described in more detail with reference to the accompanying drawing. It is noted that the subsequently outlined and described aspects or embodiments may be combined such that some or all of the aspects/embodiments are implemented within one embodiment. Further, it is noted that when referring to “resources”, in this description, a resource is to be understood as comprising one or more of the following:
one or more symbols,
one or more time slots or subframes or frames,
one or more frequencies or carriers or subchannels or group of subchannels,
one or more frequency bands, like unlicensed subbands,
one or more bandwidth parts,
one or more resource pools,
one or more LBT sub-bands,
one or more spatial resources, e.g., using spatial multiplexing.

### First Aspect

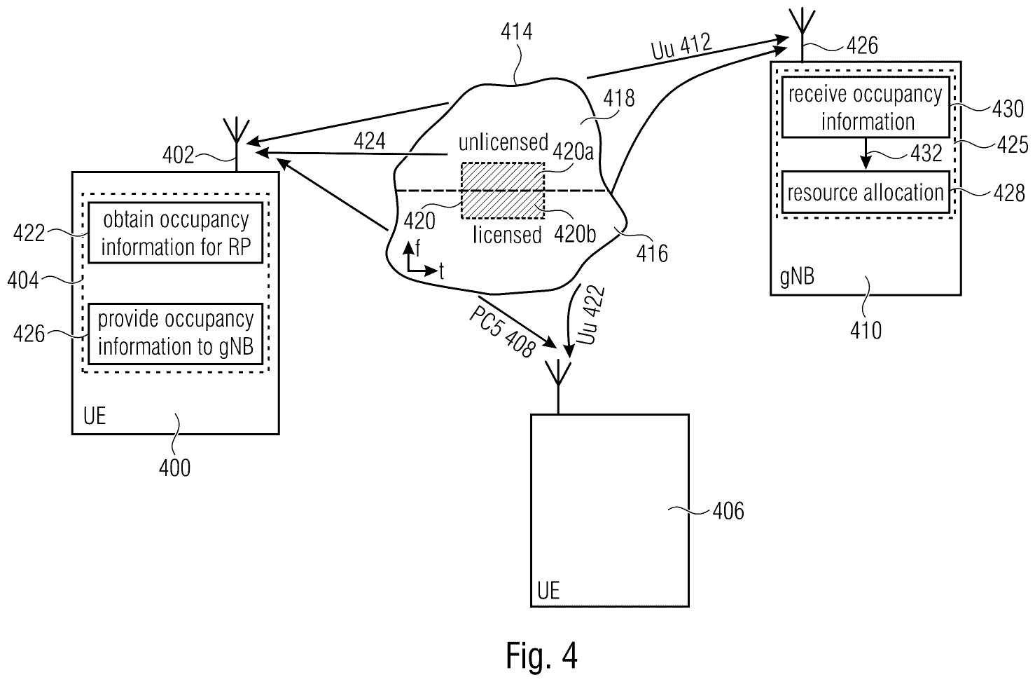

Embodiments of the first aspect are now described in more detail. FIG. 4 illustrates a user device, UE, in accordance with an embodiment of the first aspect. The UE, also referred to as sidelink UE, SL-UE, 400 comprises one or more antennas 402 and a signal processor 404 for performing one or more operations, for example operations involving the antenna 402, like transmitting/receiving data, like payload data or control data. UE 400 is operated in a wireless communication system, like the one descried above with reference to FIG. 1A to FIG. 3, for example a 3rd generation partnership project, 3GPP system or network. UE 400 is to communicate with other UEs, like UE 406, using the sidelink or PC5 interface, as is schematically illustrated at 408. Moreover, UE 400 is connected to the base station or gNB 410 and receives via the Uu interface 412 resources allocated by the gNB 410 that are to be used by the UE 400 for the communication over the sidelink 408. FIG. 4 further illustrates, schematically, the spectrum 414, like the radio spectrum including the resources to be used for a communication within the wireless communication system or network. The resources allocated by the base station 410 to the UE 400 may comprise one or more of the following: one or more symbols, one or more time slots or subframes or frames, one or more frequencies or carriers or subchannels or group of subchannels, one or more frequency bands.

As is further illustrated, schematically, the spectrum 414 comprises the licensed spectrum 416 and the unlicensed spectrum 418. The licensed spectrum 416 is the part of the spectrum that is reserved for the wireless communication system including the UEs 400 and 406 as well as the base station 410. In other words, resources in the licensed spectrum are for exclusive use by this wireless system. The unlicensed spectrum 418 includes resources that may be used by a plurality of wireless communication systems, for example by another wireless communication system in accordance with the 3GPP standard but operated by a different operator, or by systems using a different radio access technology, like WiFi or Bluetooth.

In accordance with embodiments, for the sidelink communication a resource pool 420, also referred to as sidelink resource pool, SL-RP, may be provided, and the UE 400 is configured or preconfigured with the resource pool 420. The resource pool may include resources from the unlicensed spectrum 418 only or, as is depicted in the embodiment of FIG. 4, may comprise resources from the licensed spectrum 416 and from the unlicensed spectrum 420. In accordance with further embodiments, the resources in the unlicensed spectrum may be aggregated using carrier aggregation.

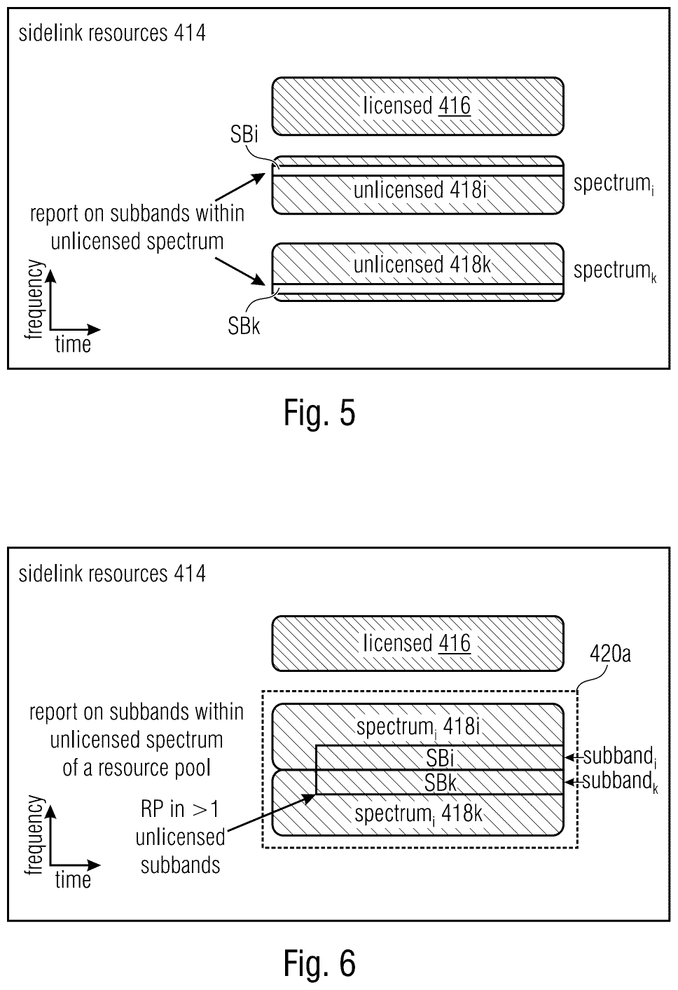

FIG. 5 illustrates, schematically, the spectrum 414, like the radio spectrum including the resources to be used for a communication within the wireless communication system or network. The spectrum 414 comprises the licensed spectrum 416 and the unlicensed spectra 418i and 418k. The licensed spectrum 416 is the part of the spectrum that is reserved for the wireless communication system including the UEs 400 and 406 as well as the base station 410. The unlicensed spectra 418i, 418k includes resources that may be used by a plurality of wireless communication systems. FIG. 5 illustrates an embodiment where the UE 400 reports on one or more subbands SBi, SBk within the unlicensed spectra 418i, 418k. The unlicensed spectra 418i, 418k spectrum may be in one or more resource pools and/or may be in different frequency regions.

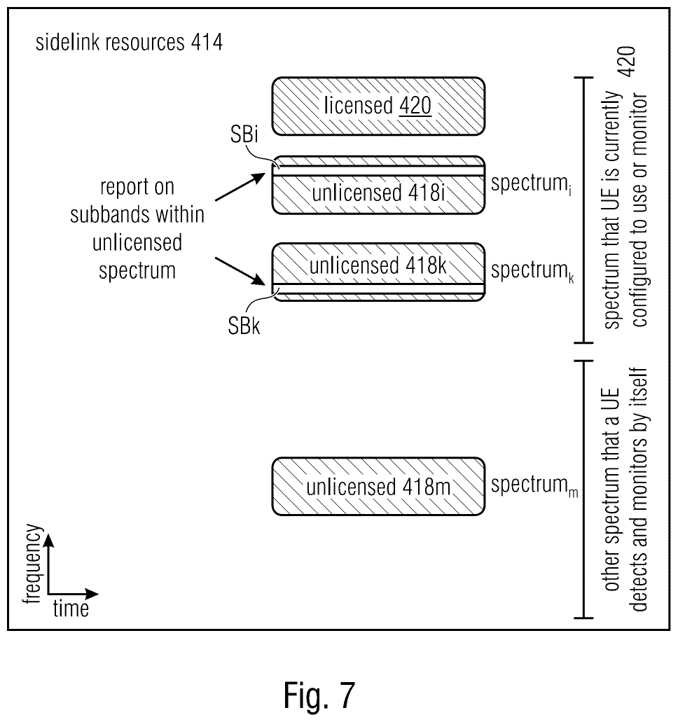

FIG. 6 is similar to FIG. 5 and illustrates an embodiment where the UE 400 reports on subbands SBi SBk which belong logically to the same resource pool 420a, but which may be in different physical resources, e.g., the different spectra 418i, 418k each having a different center frequency and bandwidth.

### Occupancy Information Directly Indicating Status of Resources

In accordance with embodiments of the first aspect of the present invention, UE 400 obtains occupancy information for the resource pool 420, as is indicated at 422, for example by performing certain operations or measurements 424 in the unlicensed spectrum so as to obtain occupancy information for the resources, at least the resources in the unlicensed spectrum, of the resource pool 420. This occupancy information, as is indicated at 426, is forwarded by UE 400 to the gNB 410 via the Uu interface 412 thereby assisting the gNB 410 in the resource allocation of resources in the unlicensed spectrum like resource from the resource pool 420 being in the unlicensed spectrum 418.

Thus, in accordance with embodiments of the first aspect of the present invention, a situation is addressed in which the gNB 410 may not be aware of other devices from other RATs that are accessing one or more resources within the unlicensed spectrum, like the unlicensed resource pool 420. The first aspect of the present invention resolves this problem by providing the UE 400 that sends the occupancy information for the RP 420, like a resource pool status report, via the Uu interface 412 to the gNB 410. The resource pool status report may be, for example, a channel busy ratio, CBR, or a detailed report about the occupancy in the coverage area of the gNB or within a certain zone of the coverage area of the gNB 410, for example a report as is described in more detail in WO 2019/096705 A1, the content of which is incorporated hereby by reference. Note, it is also possible that the UE transmits indirect information on the channel occupancy status by transmitting one or more KPIs regarding the unlicensed spectrum to the gNB, e.g., the amount of unicast/groupcast/broadcast traffic it can decode in the respective unlicensed band, or a 1-bit signaling whether the UE can decode data in this unlicensed band or not. From the latter information the gNB can convey if there is non-3GPP traffic being transmitted in this band, or if there is LTE or NR traffic transported within this band.

Thus, in accordance with the first aspect of the present invention, the gNB 410 is made aware of available or occupied resources, like subbands or subchannels, in the unlicensed spectrum by the report which, on the basis of the CBR but also on the basis of other indicators, such as RSSI, RSRQ, SINR, interference power or any combination thereof, may indicate the occupancy status of one or more resources in the unlicensed spectrum 418 of the resource pool 420. This allows the gNB 410 to control the resource allocation process for allocating resources to the UE 400 for the direct communication with UE 406 over the sidelink 408 in such a way that unavailable or occupied resources in the unlicensed spectrum 418 are not scheduled.

In accordance with embodiments, the occupancy information may be obtained by the UE 400 in different ways. For example, the UE 400 may perform a listen-before-talk, LBT, procedure on one or more of the resources in the unlicensed spectrum 418. The LBT procedure is a well-known and understood procedure, which allows sensing the resource or channel for a certain time to determine if it is free. In case UE 400 determines the resource in the unlicensed spectrum 418 to be free for a certain time interval, this is signaled as occupancy information to the gNB 410 so that the gNB 410 may include the free resource or channels into its resource allocation. On the other hand, in case the sensed resource or channel is not free, this result is also forwarded to the gNB 410 which, as a consequence, excludes the resource(s) from its resource allocation.

In accordance with other embodiments, the UE may simply detect one or more energy levels on one or more of the resources of the resource pool 420, for example, on one or more unlicensed subbands. For example, the UE may determine by means of the measurements 424, the receive signal strength indication, RSSI, the signal to noise ratio, SNR, or the signal to noise interference ratio, SINR. Also, a combination of some or all of these signals may be determined by the measurement 424, and in case an energy level detected is at or above a configured or preconfigured threshold, UE 400 judges the resource to be occupied and signals this information to the gNB 410 which causes the gNB 410 to exclude the respective resource from the resource allocation process.

The LBT procedure and/or the detection of the energy levels may be applied for non-3GPP radio access techniques or technologies that may use different frame structures at slot boundary, i.e., systems that do not respect the frame and slot borders of the 3GPP system so that the UE 400 may not be able to understand or decode the control information transmitted by devices of such a non-3GPP RAT.

In accordance with yet other embodiments, in case a further wireless communication network or system, which transmits on the resources of the unlicensed part of the resource pool 420, is also a 3GPP system, i.e., uses the same RAT or is within the 3GPP family, UE 400 may perform measurements 424 of pilot symbols so as to determine for the respective resources one or more measured values, for example, a 3GPP reference signal receive power, RSRP, or a 3GPP reference signal receive quality, RSRQ. In case the measured value is at or above a certain threshold, the associated resource may be signaled in the occupancy information to the gNB 410 which, in turn, may exclude the resource from the resource allocation.

In accordance with further embodiments, in such a situation, the UE 400 may also be able to decode from the resources in the unlicensed part of the resource pool 420 one or more sidelink assistance information messages, AIMs, that carry information from other UEs indicating available/non-available resources or resources that are likely to cause a collision. The latter is also referred to as collision indicator. Furthermore, an AIM can indicate a non-preferred set of resources or a set of preferred resources. The reason for a preference or non-preference can depend on a criterion, e.g., the interference situation, whether the UE sending the AIM is an intended receiver, or the SNR of a set of resources.

Also an inter-UE coordination, IUC, message may be decoded that is included, for example, within a two stage SCI on the physical layer either in the first stage or in the second stage, or within MAC control elements, MAC-CEs, or is signaled using RRC signaling or sent via other higher layer signaling. In accordance with yet further embodiments, the UE may decode certain control messages transmitted on the one or more resources evaluated in the unlicensed spectrum 420, for example, a 3GPP sidelink control information, SCI. Based on the decoded one or more SCIs information on other transmissions that are currently ongoing or scheduled for the future or information about a remaining duration of an ongoing transmission may be extracted. For example, certain reservations of the resource in the future which are transmitted in control messages previous to actually using the resource for a transmission, may be obtained. In other words, by decoding the SCI, the UE 400 may derive occupancy information for the resources, which are reserved by the SCI.

In accordance with other embodiments, UE 400 may include a circuitry allowing the decoding of control information from one or more RATs that are different from the UE's RAT, for example, it may include a Wi-Fi or Bluetooth circuit. In such embodiments, UE 400 may decode 424 control information transmitted on resources in the unlicensed spectrum of the resource pool 420, associated with the different RAT, for example, a length field in an IEEE 802.11 physical layer convergence protocol, PLCP, header, e.g., like a network allocation vector (NAV), indicating the duration that the device sending the control information intends to transmit. Note, this inter-RAT cross-functionality may involve exchanging measurements from one RAT performed in a lower layer, e.g., PHY or MAC, via a higher layer protocol, e.g., IP, with another RAT, which then has to forward this information to the respective entities, e.g., the radio resource management.

The above measurements 424 may be used independently or in combination, if possible, so as to provide the gNB 420 with occupancy information of the one or more resources of the resource pool 420 at least in the unlicensed band or spectrum 418 for allowing the gNB 410 to remove or disregard occupied resources during the allocation process used for allocating resources to the UE 400 for the sidelink communication 408 to UE 406.

In accordance with embodiments, based on the obtained occupancy information, the UE may determine a measured value, also referred to as an occupancy value, and on the basis of the measured value or the occupancy value, it is determined whether a resource, like an unlicensed subband in the resource pool 420, is occupied, unavailable or busy. Determining the occupancy status of the one or more resources measured by the UE may depend on whether the one or more measured resources are occupied or used by a 3GPP RAT, like a wireless communication network operated by a different mobile network operator, MNO, or whether the one or more resources measured are used by non-3GPP RATs, like Wi-Fi or Bluetooth systems. In case the one or more measured resources are used by a 3GPP system, a resource may be judged to be occupied, unavailable or busy in case an average of the determined measured or occupancy value over the entire resource exceeds a configured or preconfigured threshold. For example, when considering as a resource a plurality of resources in the time/frequency grid, like a subband in the unlicensed spectrum of the resource pool 420, measurements may be performed on some or all of the frequencies within the subband, and respective measured or occupancy values are obtained for each measured frequency. In case an average of the determined values over the entire band exceeds a configured or preconfigured threshold, the subband is judged to be occupied. In accordance with other embodiments, the resource, like the above-mentioned subband, may be considered to be occupied in case any one of the determined measured values or occupancy values exceeds the configured or preconfigured threshold. In accordance with other embodiments, a resource, like the above-mentioned subband, may be judged to be occupied, in case some measured values or occupancy values exceed the threshold at least for a configured or preconfigured duration. The measured or occupancy values may be obtained consecutively or non-consecutively over the resource, like the subband, for example, for only every second frequency or for a first number of frequencies following by a gap and then by a second number of frequencies. In accordance with yet other embodiments, the resource may be judged to be occupied in case one or some or all measured values or occupancy values, which were obtained or determined for the resource exceed the threshold. In accordance with other embodiments, the resource may be considered to be occupied in case the UE was able to decode a control message, which indicates an ongoing or upcoming transmission using the resource.

In the above description, reference was made to the measured value or occupancy value, which means it can be determined by one or more of the following:
RSRP or RSRQ, measured on pilot symbols, e.g., demodulation reference symbols (DMRS) pilot tones or phase tracking (PT) pilots,
RSSI, energy detection,
SNR or SINR, signal to noise ratio or signal to interference and noise ratio,
information derived from analyzing the channel state information (CSI), e.g., the computed CQI or supported MCS level on a given set of resource,
based on decoding of a resource map, indicated in a
   PHY message based on decoding of SCI, e.g., 1^{st} or 2^{nd}-stage SCI,
   Decoding of actual time/frequency allocations, e.g., TRIV/FRIV-fields,
   Decoding of messages used for beam management, e.g., SSBs, SRS,
   Decoding of a assistance information message (AIM) or IUC, e.g., depending on the content of the AIM, e.g., a set of preferred or non-preferred set of resource,
   Broadcast message, e.g., decoding of MIBs, SIBs,
   Correlation of synchronization messages, e.g., SYNC preambles,
   Based on a high-layer resource map or set of resource indicated via MAC CE, RRC, or any other higher layer protocol,
decoding of WiFi signals, e.g., measurement of RSSI based on correlation of preambles sent by a WiFi access point or WiFi terminal,
received channel power indicator (RCPI), which is used in WiFi systems, and which is a measure of the received radio frequency power in a selected channel over the preamble and the entire received frame.

In case the one or more resources measured by UE 400 are used by a non-3GPP system, judging whether a resource is available may require a different action, for example, because non-3GPP RATs do not make use of the boundaries, e.g., slot boundaries or radio frame structure, of a 3GPP system, like the inventive wireless communication system, so that partial overlaps are expected. For example, an IEEE 802.11 device may occupy only the first or second OFDM symbols of a slot, but not the rest, and, therefore, to determine whether a resource is occupied by a non-3GPP RAT, in accordance with embodiments, the above-described detected one or more energy levels over an entire resource may be averaged and in case a configured or preconfigured energy threshold is exceeded, the resource is considered to be occupied. When considering the above-mentioned example of measuring an unlicensed subband in the resource pool 420, respective energy levels may be obtained on the respective carriers forming the subband and an average of the detected energy levels over the entire subband is the basis for judging whether the subband, i.e., the resource, is occupied or not. In accordance with other embodiments, the resource, like the mentioned subband, may be considered to be occupied in case any one of the detected energy levels for the resource exceeds the energy detection threshold. In accordance with yet other embodiments, the resource, like the subband, may be considered to be occupied in case one or more detected energy levels obtained for consecutive or non-consecutive parts of the subband, like consecutive or non-consecutive frequencies or carriers exceeds the energy detection threshold at least for a configured or pre-configured duration. In accordance with yet other embodiments, the resource, like the subband, may be considered to be occupied in case set of detected energy levels for the resource exceeds the energy detection threshold. In accordance with yet other embodiments, the resource, like the subband, may be considered to be occupied only in case all of the detected energy levels exceed the energy detection threshold. Moreover, in situations in which the UE 400 is capable to decode information transmitted by the non-3GPP system, the UE 400 may judge the resource, like the mentioned subband, to be occupied in case a decoded control message indicates an ongoing or upcoming transmission using the resource, like the subband. In accordance with other embodiments, UE 400 may also be capable to detect a preamble associated with a transmission currently performed using the measured subband, which indicates an ongoing or upcoming transmission, so that the UE, based on the detection of the preamble, without the need for decoding it, may judge the resource to be occupied.

In accordance with embodiments, UE 400 may report to the gNB or base station 410 either the obtained occupancy information in the form of the measured or detected or decoded information so that, using the information received over the Uu interface 412, the gNB 410 may determine the actual occupancy status by itself. In other words, the above-described results of the measurements 424 performed by UE 400 may be forwarded to the gNB 410 over the Uu interface 412 using a configured or preconfigured report configuration for allowing the gNB 410 to determine the occupancy status of the one or more resources in the unlicensed spectrum of the resource pool 420 to be used for the sidelink communication. For example, the gNB 410 may determine whether a resource is occupied on the basis of the received information in a way as described above with reference to the UE performing the determination of the occupancy status. In such embodiments, a report provided by UE 400 to gNB 410 may indicate for some or all of the resources of the resource pool 420 information obtained from the resources, for example, the above-mentioned detected energy levels or the determined measured or occupancy values, or the decoded control information.

In accordance with other embodiments, the UE may determine the actual occupancy status of the one or more resources in a way as described above and include into the report transmitted to the gNB 410 the actual occupancy status. In accordance with such embodiments, the report may indicate for some or all resources of the resource pool 420, especially for the resources in the unlicensed spectrum, the occupancy status, for example, a congestion indication, like a single bit or a certain value, per resource indicating whether the resources are occupied or not. The congestion indication may be given per subband or subchannel or per group of subbands or subchannels or per resource pool or per bandwidth part, BWP. In accordance with such embodiments, the report is a full-fledged report when providing the occupancy status for all of the resources, and the occupancy status may be indicated in a way similar as described in WO 2019/096705 A1 mentioned above.

In accordance with other embodiments, only a so-called mid report may be provided in accordance with which UE 400 reports the occupancy status, for example, per subband or per group of subband or per group of subchannels or per timeslot.

In accordance with yet other embodiments, the report may indicate for the entire part of the resource pool 420 being in the unlicensed spectrum 418 the occupancy status, for example, a percentage at which the resources in the unlicensed spectrum 418 are occupied or non-occupied. Moreover, a CBR-like report may be provided indicating the occupancy status of the entire resource pool 420 or the occupancy status of the resources of the resource pool 420 being in the unlicensed spectrum 418.

In accordance with other embodiments, the report may include one or more occupancy statuses indicating a percentage at which the unlicensed resources belonging to a certain LBT subband are occupied.

Thus, in accordance with embodiments, the report may be of a type that contains the energy information of some or all of the resources measured, or it may contain an indication of the available/unavailable resources, which has been obtained using the energy information, or it may contain an information indicating available/unavailable resources, determined on the basis of the energy information, which are available/unavailable because other 3GPP UEs occupy the resources or because a non-3GPP devices occupy the resources, or a combination of both. Also, as mentioned above, an overall occupancy value for the resource pool or at least the part thereof being in the unlicensed spectrum 418 may be provided by means of the report.

In accordance with embodiments, the UE 400 may provide the report with different granularity levels, for example, by providing an exact bit map or by providing the results with a time and/or frequency and/or spatial domain granularity. In accordance with other embodiments, the report may be provided with a coarser granularity, for example, it may be provided based on one or more subchannels or frequency bands. For example, when providing a fine granularity, the report may be provided with a physical layer, PHY, based granularity by using, for example, a time resource indicator value, TRIV, or a frequency resource indicator value, FRIV, or the above-mentioned bitmap. The quasi granularity may be on the basis of a subchannel or a group of subchannels or even on the basis of the entire resource pool. Also note that a UE may provide the report with a coarser granularity, which can cause a gNB or other UE, based on the reception of this coarse report, to send a trigger to the same or another UE within the vicinity of the given UE, to trigger a finer granular report or an additional report. This can be used in order to improve the certainty of the results given in the initial report and thus help the gNB or other UE, to better align resources and avoid resource collisions in the particular set of resources.

Thus, the report may indicate the occupancy status for one or more of the following:
a single time entity and/or frequency entity and/or spatial entity of the resource pool 420, at least for the unlicensed part thereof, for example, for a certain resource bock, RB,
a group of RBs of the resource pool,
a subchannel in the resource pool 420,
a group of continuous or non-continuous subchannels of the resource pool 420,
a timeslot of the resource pool 420,
a group of continuous or non-continuous/discontinuous timeslots of the resource pool 420.

In accordance with other embodiments, UE 400 may provide a report indicating an occupancy status for resources used by a 3GPP system only, like an LTE-only report or an NR-only report, or may indicate the occupancy status for resources used by a non-3GPP system only, like a non-3GPP-RAT report, or may indicate the occupancy status for resources used by a 3GPP system and used by a non-3GPP system. In other words, the UE may provide the report either as a single report for all measurements performed or as separate reports distinguishing between 3GPP-RAT and non-3GPP-RAT. When using a single report, the measurement results may be indicated by configured or preconfigured values associating them with either the 3GPP system or the non-3GPP system in case they are occupied and with another values indicating a resource to be non-occupied or unoccupied. In other words, in accordance with embodiments, the report may not only indicate that a certain resource is occupied, but it may also indicate that a certain resource is non-occupied so as to give a complete picture of all resources measured by the UE 400 in the report. For example, a resource that was measured to be occupied based on the RSRP measurement may be indicated by a “one”, i.e., indicating that the resource is associated with a 3GPP-RAT, and in case it was determined to be occupied because of an energy measurement, it may be associated with another value, like “two” indicating that the resource is used by a non-3GPP-RAT. Moreover, the report may indicate a resource to be occupied by assigning a certain predefined value, like “zero” to the resource in the report.

As described, the resources in the unlicensed spectrum 418 may be occupied because of transmissions performed by systems operating in accordance with the 3GPP-technology and/or by systems operating in accordance with a non-3GPP-technology. When reporting the occupancy status for resources used by other elements of the 3GPP RAT family, like UEs of a 3GPP wireless communication network of a MNO different from the MNO of the network in which UE 400 is located, the report may include, for enhancing the resource allocation for the sidelink communication at the gNB 410, one or more of the following resources used by one or more entities of a 3GPP wireless communication network of a different MNO:
resources which are occupied by another gNB,
resources which are occupied by another user device, UE,
resources which are occupied by another V2X-UE, VUE,
resources that are used for backhauling, for example, by a gNB or by an IAB node,
resources which are used for V2X traffic by a gNB or by a UE,
resources that are used by a pedestrian UE, PUE,
resources that are used by infrastructure equipment, for example by a roadside unit, RSU,
resources that are used by an industrial user device, e.g., an IUE,
resources that are used by any other device communicating via the sidelink interface, e.g., via PC5,
resources that are used by a user device, like a UE or a VUE.

Referring to the list above, the occupancy status may also indicate when a resource is not occupied, e.g., that the resources are not occupied by another gNB, UE, VUE, IAB link, V2X traffic, PUE, RSU, IUE or other sidelink device. Furthermore, the report may contain information on how many resources are used, in which subbands, how much transmit power is used and the time duration these resource are occupied.

The above-mentioned information or side information may be used by the gNB 410 to optimize the resources to be used for the UEs connected to the gNB 410, like UEs 400 and 406 in FIG. 4. For example, if the gNB 410 is aware that certain resources are used by an RSU, the gNB 410 may conclude that this RSU may transmit with a higher transmit power and, thus, expects a higher interference on the resources. Moreover, the gNB 410 may conclude that the resources are used in a fixed location such that an interference is confined to a certain geographical area. In another example, if one or more WiFi APs are detected, it is likely that these belong to a fixed installation, and that interference coming from these WiFi APs are contained to a certain geographical area. On the other hand, if the resources are used by another UE, the gNB may conclude, depending on a mobility status of the UE, that the interference is traveling or moving through the cell and may only be existent at a certain location temporarily.

In accordance with further embodiments, the above-described report may be provided by UE 400 to another UE, like UE 406 or to another entity, like a RSU. The report may be distributed by the gNB via the Uu interface to the respective entities or by the UE 400 using the sidelink 408, e.g. via PC5. In accordance with embodiments, responsive to providing the report to the RSU, which in the context of the present application may be considered a base station, the RSU may adjust its resource usage in the unlicensed spectrum dependent on the occupancy of the resources.

UE 400 may transmit the above-described report to the base station, like gNB 410 or to any other network entity, like an RSU or another UE, responsive to a certain request, for example, responsive to a request from a core network, CN, entity, or from the base station 410, or from a road side unit, RSU, or from another UE. UE 400 may transmit the above-described report also responsive to one or more configured or preconfigured triggers, or periodically or semi-statically in accordance with a certain configuration or pre-configuration.

The one or more configured or preconfigured triggers may comprise a change in measurement values by a configured or preconfigured threshold. For example, a certain change in the channel busy ratio, CBR, or in the signal to interference and noise ratio, SINR, may cause the UE to send the report to the one or more mentioned network entities, like the gNB 410, so as to inform the other network entities about a substantial change in the occupancy status of at least the unlicensed part of the resource pool 420 for allowing the gNB 410 to adjust its resource allocation procedure accordingly. In accordance with other embodiments, the report may also be triggered in case one or more of the measurements 424 performed by the UE 400 yield a value that exceeds a configured or preconfigured threshold. In a further embodiment, a UE similar to the UE 400, might be only served on a licensed carrier, and congestion experienced on the said licensed carrier, e.g., measured in terms of interference or NACKs received upon data transmissions via PSSCH, can trigger the UE to send such a report to a gNB, in order to indicate that it is better served within the unlicensed spectrum. Furthermore, a handover or conditional handover (CHO) may also be a trigger for the UE to send such a report to the gNB or to another UE or RSU.

In case the UE 400 judges the occupancy of resources using the LBT procedure, the sending of the report may be triggered in case the UE 400 experienced a certain number of LBT failures on the monitored unlicensed resources.

In accordance with other embodiments, UE 400 may send the report together with sending a scheduling request or a buffer status report, BSR, to the gNB 410, i.e., in situations in which the UE 400 requests resources for a sidelink communication, it may also provide the report about the occupancy status of the unlicensed resources for allowing the gNB 410 to adapt its resource allocation in this part of the spectrum accordingly.

In case UE 400 implements for certain transmissions the HARQ procedure, a sending of the report concerning the occupancy status of the unlicensed resources of the resource pool 420 may be triggered in case a number of HARQ non-acknowledgements, NACKs, exceeds a certain number, i.e., in case, by means of the NACKs it is determined that transmissions on the unlicensed spectrum become more and more unsuccessful, which indicates that a scheduling of the resources in this part of the unlicensed spectrum needs to be reconsidered, which may be done by the gNB using the report about the occupancy status.

In accordance with other embodiments, the report may be sent responsive to a feedback received via a feedback channel, like the physical sidelink feedback channel, PSFCH. For example, the feedback may be a collision indicator, CI, including details about past or potential future collisions on a resource.

In accordance with other embodiments, the report may be sent responsive to receiving an assistance information message, AIM, or an inter-UE coordination, IUC, message send by another UE or RSU. The message may include or contain a set of preferred resources or non-preferred resources, i.e., it specifies resources considered by another UE to be available or not available for a communication.

In accordance with embodiments, the occupancy information is one or more of
a Channel Busy Ratio, CBR,
a congestion indication, e.g., a number of Physical Channel Identifiers, PCIDs, seen, or a number of UE IDs detected,
a radio resource map of some or all occupied and/or free resources, subbands, resource pools, BWPs, component carriers,
a minimum or maximum or average or predicted channel access time, e.g., how long the UE has to contend for channel access, e.g., using LBT
a simple indication, e.g., using a 1-bit field, indicating that there is activity in the subband or RP,
an indirect indication, e.g., by only indicating the congestion status for a subband, which is indicative for the usage of a whole set of subbands, RPs or carrier.
   Moreover, in accordance with other embodiments, the report may be sent once a configured or preconfigured timer has lapsed.

### Occupancy Information Indicating Use of the Unlicensed Spectrum

In accordance with above described embodiments of the first aspect, the occupancy information directly indicates whether one or more or all resources in the unlicensed spectrum, like the resources in the first SL-RP, are currently used or occupied. However, the present invention is not limited to this kind of occupancy information. In accordance with other embodiments of the first aspect, the occupancy information may be information indicating, instead an exact occupancy map for the resources of the SL-RP, a use of the unlicensed spectrum. In accordance with embodiments, the information regarding the use of the unlicensed spectrum may include one or more of the following:
The operator using the unlicensed spectrum, for example, in case the unlicensed spectrum is used by an operator using a 3GPP-like technology. This may be determined on the basis of a physical cell ID (PCID) used in the unlicensed spectrum. The mentioned operator is a mobile network operator that is different from the MNO of the wireless communication system to which the UE 400, the gNB 410 and the UE 406 belong to.
The radio access technology, RAT, making use of the resource may be signaled, for example, whether the resource is occupied by entities of a 3GPP RAT or by entities of a non-3GPP RAT, like Wi-Fi, Bluetooth, or Bluetooth low energy, BLE.
A physical cell ID (PCID), e.g., linked to the resources used in the unlicensed spectrum.
Any other type of cell identifier, e.g., a WiFi SSID or a Bluetooth or BLE identifier,
A resource pool ID of a different 3GPP wireless communication system.
A geolocation of the UE 400 or of the node using the unlicensed spectrum may be provided, for example, on the basis of the UEs knowledge about a zone within which it is located or on the basis of its exact location coordinates, obtained, for example, by a UE positioning algorithm, or in terms of a range between the UE and the other node using the unlicensed spectrum, or any other type of distance measure, e.g., indicating the distance between gNB und UE or between UE and a potential user of the unlicensed spectrum. The geolocation or range can also be encoded in a fingerprint, which is then reported to the gNB, in order for the gNB to store this information to classify the information reported, and in order store or compare the reported information with similar information received in an earlier report.
A source ID and/or a destination ID of another entity, like another UE, using the occupied resources.
An indication of usage of unlicensed resources by the UE itself and/or details on the usage may be provided, for example, how many resources are used, what subbands are used, how much transmit power on the bands is used, the time duration of usage and the like. For example, this information may be provided so as to indicate situations in which the UE 400 operates as a Wi-Fi hotspot, provides for a Bluetooth audio connection or for a Bluetooth data connection, BLE.
Any information on the type of traffic transmitted on the resources in the unlicensed spectrum, e.g., a cast-type, or a QoS-class.
Information on the congestion status, e.g., a congestion flag, of the resources in the unlicensed spectrum.
Information on the resource usage of a 2^{nd} unlicensed spectrum that it currently is not configured to be used by the UE, but is monitored by the UE.
Channel state information, CSI, or other information required for beam management or beam steering.

As mentioned above, the information regarding the use of the unlicensed spectrum may include Information on the resource usage of a 2^{nd} unlicensed spectrum that it currently is not configured to be used by the UE, but is monitored by the UE. FIG. 7 illustrates, similar as FIG. 5, the spectrum 414, like the radio spectrum including the resources to be used for a communication within the wireless communication system or network. The spectrum 414 comprises the licensed spectrum 416 and the unlicensed spectra 418i and 418k which may be the SL-RP 420 to be used by the UE 400. In addition, unlicensed spectrum 418m is shown that may not be part of the RP 420 but the UE 400 is capable to also monitor this spectrum. FIG. 7 illustrates an embodiment, where UE 400 is configured with one or more unlicensed carriers or subbands SBi, SBk in the unlicensed spectra 418i, 418k and where UE 400 may report on these subbands SBi, SBk. In addition, UE 400 reports on another unlicensed carrier, e.g., within spectrum 418m, which it may perform sensing on and which the gNB 410 may not be aware of. In this case, UE 400 may recommend to the gNB 410 to reconfigure UE 400 so that also spectrum 418m may be used, since it proposes a better spectrum candidate to the gNB, e.g., in case the configured unlicensed spectra 418i, 418k are heavily used.

As described above, the occupancy information may be used for assisting the base station 410 in its resource allocation and selection.

### Base Station

Further embodiments of the first aspect of the present invention provide a base station, like a gNB or an RSU or the like, which is used for allocating resources to a sidelink UE from the unlicensed spectrum covered by a resource pool dependent on occupancy information for the resources in the resource pool, which is provided from the sidelink UE. FIG. 4 illustrates an embodiment of the base station 410, which operates in the wireless communication system together with the UE 400. Although FIG. 4 illustrates only two UEs, the base station 410 may serve a plurality of UEs some or all of which being capable of a sidelink communication with other UEs. The gNB 410 includes a signal processor 425 and one or more antennas 426 for the wireless communication with the other network entities, like UEs 400 and 406. The signal processor 425 is provided so as to implement the embodiments of the first aspect of the present invention as is now be described in more detail. As is indicated in FIG. 4, gNB 410 is connected to the plurality of UEs 400, 406 via the Uu interfaces 412, 422, and UEs 400 and 406 may communicate directly with each other over the sidelink 408. The gNB 410 allocates, as is indicated at 428 resources to the UEs 400, 406 for a sidelink communication over the sidelink 408.

In accordance with embodiments of the first aspect of the present invention, gNB 410, as is indicated at 430, receives from the UEs, like from UE 400, occupancy information for the resources in the unlicensed spectrum, for example, occupancy information of those resources of the resource pool 420 configured by the system for the sidelink communication, which are within the unlicensed spectrum 418. As is indicated at 430, the occupancy information is used by the gNB for the resource allocation 428.

For example, in accordance with embodiments, dependent on the received occupancy information 430, gNB 410 may determine that sufficient resources are available in the unlicensed spectrum for a transmission over the sidelink so that it is possible to offload transmissions of the UE 400 over the sidelink 408 to UE 406 from the licensed spectrum 416 to the unlicensed spectrum. In case the occupancy information indicates that such offloading is possible, the resource allocation 428 allocates the respective resources available in the unlicensed part of the resource pool 420 for a sidelink transmission by UE 400.

The occupancy information may be received in the form of the above-described report provided by UE 400 so that the gNB either receives the actual occupancy status of the unlicensed resources or receives the measurements performed by UE 400 and determines, using the received measurements, the actual occupancy status.

In the embodiments described above, reference is also made to the resource pool 420 including resources in the licensed spectrum 416 and resources in the unlicensed spectrum 418. However, in accordance with other embodiments, the resources may include only resources in the unlicensed spectrum, as is schematically represented in FIG. 4 by resource pool 420a, while another resource pool 420b may be provided in the licensed spectrum. It is noted that the two resource pools do not need to be adjacent to each other as is indicated in FIG. 4, rather, they may be located at difference parts of the respective spectra. Also, in accordance with further embodiments, more than one resource pool 420a and more than one resource pool 420b for the sidelink communication in the licensed and unlicensed spectra may be provided so that, for example, dependent on the received occupancy information, the gNB 410 may decide to switch from one resource pool, which has as an undesirable occupancy status for some or all resources in the unlicensed spectrum, to another resource pool having unlicensed resources being less occupied. For example, gNB 410 may trigger a handover from one resource pool to another resource pool dependent on the received occupancy information. In accordance with embodiments, dependent on certain events, the gNB 410 may send, via the Uu interface 412, a request to UE 400 for sending an occupancy report for the unlicensed resources in the resource pool. For example, the gNB may trigger the sending of such a request in case the gNB wants to offload more radio resource to the unlicensed spectrum, e.g., which can occur in one or more of the following situations/conditions:
an overload condition, e.g., the gNB has to serve more UEs with a certain QoS as expected, and it wants to push a subset of the UEs to use fully or partially the unlicensed spectrum,.
in case the gNB/operator has to free-up licensed spectrum, e.g., in case the licensed spectrum does not belong to the operator and is used in a licensing light mode such as in licensed share access (LSA) or licensed-assisted access (LAA) systems, or in case the gNB wants to use the licensed spectrum for other services, e.g., emergency services as in a public protection disaster relief (PPDR) use case, or wants to use this for inband backhauling to transmit data via Xn or NG or S1 or X2 interface,
in case the gNB wants to perform power saving, e.g., by turning off antennas or power amplifiers or whole gNB-sites, and wants to transfer as many UEs as possible to use unlicensed spectrum, such that it does not have to coordinate spectrum in the licensed band for these UEs, and can shut down its service or reduce the power in a licensed band. This can also be part of an interference reduction scheme within the operator's network, or this can be part of a time-savings plan, e.g., in case the gNBs are powered down at night, and stop serving UEs for certain service in a specified area. In this case, a gNB could trigger such a reporting and in return configure the said UE to use the unlicensed band during a certain time period, e.g., from 1:00 am to 5:00 am in the morning. Furthermore, in this scenario, the gNB could signal a fallback solution to the UE, in case the service quality in the unlicensed band does not fulfill the service requirement required by the said UE.
in case the gNB wants to validate previous reports,
in case of transmission or re-transmission failures
in case no current report is available.

### Second Aspect

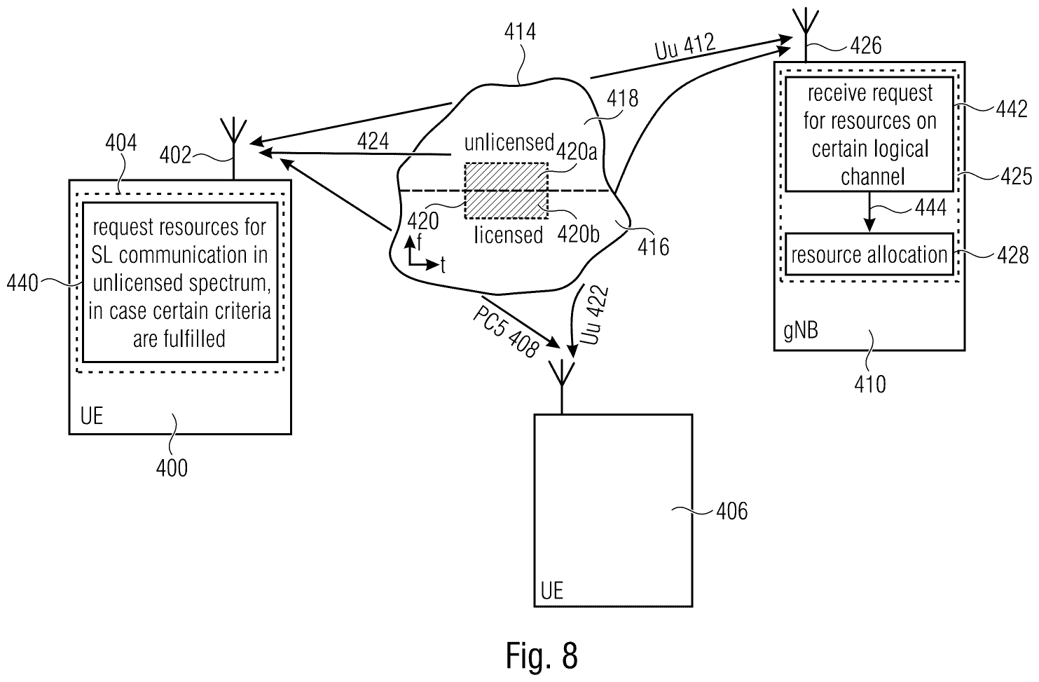

Embodiments of the second aspect are now described in more detail. In accordance with embodiments of the second aspect of the present invention, a user device, UE, capable of performing a sidelink communication with other UEs is provided and may be configured with a resource pool being at least partially in the unlicensed spectrum. The UE decides to request resources from the unlicensed spectrum dependent on certain criteria. FIG. 8 illustrates an embodiment of the second aspect of the present invention, and the system depicted in FIG. 8 is similar to the one of FIG. 4 in that the UEs 400 and 406 as well as the gNB 410 are illustrated, which communicate with each other over the Uu interfaces 412, 422 or the PC5 or sidelink interface 408 using resources from the spectrum 414, which includes the licensed spectrum 416 and the unlicensed spectrum 418. As described above with reference to FIG. 4, within the available resources, the mentioned resource pool 420 is provided, which may include resources from both the licensed and unlicensed spectra 416, 418. In accordance with other embodiments, the resource pool may only include resources from the unlicensed spectrum 418, as is indicated by resource pool 420a, and one or more further resource pools in the licensed spectrum 416, like resource pool 420b may be provided. In accordance with embodiments of the second aspect of the present invention, the signal processor 404 of the UE 400 may be implemented so as to allow UE 400, as is indicated at 440, to request from the gNB 410, either directly via the Uu interface 412 or via a relay device (not depicted in FIG. 8), like another UE, one or more resources for a transmission in the resource pool 420, more specifically, in the part of the resource pool being in the unlicensed spectrum or for resources from the resource pool 420a. However, the request is performed by UE 400 only in case one or more criteria are met.

Thus, in accordance with embodiments of the second aspect of the present invention, a UE, like UE 400, may be configured with one or more resource pools 420 that belong both to the licensed and unlicensed spectra, and for supporting the resource allocation by the gNB for the sidelink communication of the UE 400, the UE 400 may analyze measurements 424 associated with the resources of the resource pool, like the measurements described above with reference to the first aspect of the present invention, so that, for example, dependent on the outcome of the measurements, UE 400 may determine whether to request a grant, i.e., to request resources for the sidelink communication, in the licensed spectrum 416 or in the unlicensed spectrum 418. In other words, UE 400 requests a grant in the unlicensed spectrum 418 only in case UE 400 is confident of performing a transmission using the resources in the unlicensed spectrum without any collision or with a collision probability which is below a configured or preconfigured threshold. For example, this can be measured based on HARQ ACKs/NACKs received within the unlicensed carrier.

In accordance with embodiments, the criteria dependent on which the UE requests resources from the unlicensed spectrum 418 for a sidelink communication may be based on a measurement 424 of the occupancy status of the resource pool 420, at least of the occupancy status of the unlicensed resources of the resource pool. The measurements may include, for example, those measurements described in detail above with reference to the first aspect of the present invention, i.e., the measurements 424 described above with reference to FIG. 4. For example, the occupancy status of the resource pool may be indicated, and in case it is determined that it is at or above a certain threshold because the unlicensed part of the resource pool 420 or the unlicensed resource pool 420a is considered to be congested. UE 400 sends a request, like a BSR, requesting for resources for the sidelink communication from the licensed part of the resource pool 420 or from the licensed resource pool 420b.

In accordance with other embodiments, the criteria may include a BSR which indicates that a buffer of the UE 400 holds data to be transmitted over the sidelink. The buffer status report (BSR) may indicate the status of several logical channels or logical channel groups. By indicating that there is data to send in a certain channel the gNB has some information related to the logical channel and may infer target, QoS, PDP or other related parameters. So by having at least a separate LCH for licensed or unlicensed traffic the UE can indicate a preference for the grant it wants to receive.

If the UE has urgent data to transmit, e.g., data having of high priority or data having ultra-reliable low latency (URLLC) requirement, UE 400 may indicate that it also transmits data within an unlicensed set of resources to achieve the QoS requirements. UE 400 may benefit especially if a large bandwidth is available in the unlicensed spectrum, e.g., n times 100 MHz. Furthermore, UE 400 may benefit if the bandwidth opportunity of licensed and unlicensed bands is uneven, e.g., a couple of MHz usable on the licensed carrier, while hundreds of MHz are available on the unlicensed carrier. Even if UE 400 has to perform LBT on the unlicensed band, due to the large bandwidth available, it may even finish its transmission earlier then by just using a small bandwidth in the licensed band. By sending the BSR to the gNB, the gNB or network may decide how to utilize most efficiently licensed and/or unlicensed resources. This may either be decided based on additional information provided by the UE, or by the UE's initial configuration during network setup. In this way, the gNB/network know, if the given UE is configured to use licensed spectrum, unlicensed spectrum, or a combination of both. A BSR from such a UE thus signals to the gNB/network, that the given UE may also be served by using resource within unlicensed spectrum, without the UE having to provide additional signaling.

In accordance with further embodiments, UE 400 may determine to request resources from the unlicensed spectrum 418 dependent on the nature of a transmission to be carried out over the sidelink, for example, dependent on the type of message to be transmitted, a priority of the transmission, the size of the message to be transmitted and the like. For example, in case UE 400 has a cooperative awareness message, CAM, to be transmitted, which, in general is a message that needs to be transmitted periodically, is constantly refreshed and has a low priority, UE 400 may decide that such a message may be transmitted using the unlicensed band and, therefore, request resources in the unlicensed part of the resource pool. On the other hand, in case of a high priority transmission, like an ultra-reliable low latency communication, URLLC, transmission which needs to transmit delay critical data, UE 400 may decide to use the licensed spectrum as it is assumed that UE 400 competes with a lesser number of devices for the resources. In accordance with embodiments, this may also be decided by the network or gNB, in case the gNB is aware that UE 400 may also be served via unlicensed spectrum. This may either be the case if UE 400 was configured like this during initial access, of if this capability was exchanged or configured while communicating with the gNB or network prior to a future transmission.

In accordance with further embodiments, messages associated with a certain task, like messages used for a resource coordination in a group of user devices communicating with each other over the sidelink may be confined to the licensed resources, while other group messages including less critical information may be transmitted using unlicensed resources. In such embodiments, UE 400 may be referred to as the scheduling UE, S-UE, or as a group leader UE, GL-UE sending the respective group-related messages.

Further, UE 400 may decide about requesting resources from the gNB or network in the unlicensed/licensed spectra dependent on contents of a transmission, for example in case the message is used for a resource coordination among a plurality of UEs, like UEs of a group communicating using the sidelink, and such a message may be, for example, an assistance information message, AIM.

In accordance with other embodiments, UE 400 may decide about selecting resources from the licensed spectrum or from the unlicensed spectrum dependent on a grant type used on a carrier in a licensed spectrum, for example, in case the UE is operating with configured grants (CG), like Type 1 or Type 2 or SPS-like grants, but a quota exceeds that of a certain configuration. NR supports two schemes for uplink transmission without a dynamic grant, which are similar to SPS in LTE systems. If configured grant type 1 is used, an uplink grant is provided by RRC, including activation of the grant. If configured grant type 2 is used, the transmission periodicity is provided by RRC and L1/L2 control signaling is used to activate/deactivate the transmission. If a UE uses the above-defined scheduling mechanisms, and if it has more data to transmit that currently fits into the grant, it may decide to transmit the data exceeding the quota of the configured grant using additional spectrum in the unlicensed band. Furthermore, the UE may use the unlicensed band for retransmissions wrt. configured grants, or in case a configured grant was pre-empted by another transmission. Furthermore, the UE may send a copy or redundancy version of the data to be transmitted via CG using the unlicensed band, such that the probability of a successful transmission is increased.

In accordance with other embodiments, UE 400 may determine the use of the unlicensed/licensed resources dependent on the HARQ status. For example, in case UE 400 experiences for one or more transmissions over the sidelink using unlicensed resources a number of HARQ failures or HARQ NACKs to exceed a certain threshold, the transmission over the selected resources in the unlicensed spectrum may be considered to be not reliable and therefore, UE 400 may request for another transmission or for a retransmission resources from the licensed part of the resource pool. The UE may also operate in this way in case attempts to access certain resources like subchannels or channels in the unlicensed spectrum fail and a number of such failures, like failed LBTs, exceeds beyond a predefined threshold.

Another criterion may by a status on resource collisions, e.g., like a collision indicator, CI, based on past or potential future collisions, or that any other data is received via the physical sidelink feedback channel, PSFCH.

Another criterion may be the cast type of the transmission to be performed by the UE 400. For example, a unicast transmission directed to a dedicated UE via the sidelink 408 may require a higher reliability than a groupcast transmission to a set of UEs over the sidelink or a broadcast to all UEs within sidelink coverage of the UE 400 so that for the unicast type transmission, the UE is to request resources for the transmission on the sidelink in the licensed spectrum 416 whereas for a broadcast or groupcast transmission resources in the unlicensed spectrum 418 may be requested. Instead of the cast type, the decision as to whether sidelink resources are to be requested from the licensed or unlicensed spectra, the UE may determine whether the transmission of a certain message requires a HARQ feedback. For example, HARQ-less transmissions may use resources from the unlicensed spectrum 418 while transmission requiring a feedback channel are done using licensed resources.

In accordance with yet further embodiments, the criterion may be the mobility status of UE 400. For example, in case the UE is a mobile UE, like a vehicular UE, dependent on the speed at which the UE travels it may decide whether resources from the unlicensed spectrum 418 or from the licensed spectrum 416 are to be used or requested for a sidelink communication with UE 406. For example, in scenarios with a high mobility, like a mobility or speed at which the UE travels being higher than a certain threshold, UE 400 may request resources from the licensed spectrum as a validity of, for example, an occupancy report may be reduced due to the high mobility. On the other hand, in situations in which the UE 400 is stationary or travelling at a slow speed, e.g., at a speed below the threshold, the validity of the occupancy report may be more reliable.

Also, UE 400 may decide on selecting resources from the licensed/unlicensed spectra dependent on a minimum required communication range so that, for example, in case it is determined that a UE, like UE 406, is within the minimum required communication range of UE 400, sidelink resources from the unlicensed spectrum may be used as due to the proximity of the UEs a reliable communication may be assumed also when using the unlicensed spectrum. On the other hand, when it is determined that UE 406 is outside the minimum required communication range, resources from the licensed spectrum are used or requested.

In accordance with the yet further embodiments, the criterion may include a location or geolocation of UE 400 so that, for example, in case UE 400 determines to be located at a certain area where a high probability of interferences is to be expected, for example in case the UE is located in an area where WiFi hotspots are installed, this means that a transmission using unlicensed resources may not be reliable or may experience substantial interference, so that in such areas of high probability of interference UE 400 may determine to request resources for the sidelink communication in the licensed spectrum 416. On the other hand, in case an area in which the UE 400 is located is indicated to be an area with low interference, UE 400 may decide to request resources for the sidelink communication from the unlicensed spectrum 418.

As mentioned above, in accordance with embodiments, UE 400 may determine to request resources for the sidelink communication from the unlicensed/licensed spectra dependent on an occupancy status of either the part of the resource pool 420 including unlicensed resources or of the unlicensed resource pool 420a. In case the occupancy status is below a configured or preconfigured threshold, UE 400 may decide to request from gNB 410 resources for the sidelink communication 408 from the unlicensed spectrum 418. The occupancy status may be determined in accordance with embodiments of the first aspect of the present invention as described above.

In accordance with further embodiments of the second aspect of the present invention, once UE 400 selected a resource pool from which it desires to request the resource from, like resource pool 420a or resource pool 420b, an implicit mapping between a logical channel used by UE 400 for sending the request, like the BSR request, and the resources in the unlicensed spectrum, like the resource pool 420b or an unlicensed band in the spectrum 418 may be implemented. It is noted that a logical channel may be marked by a logical channel identifier (LCID). In such an embodiment, when the UE 400 transmits, for example, the BSR to the gNB 410, the BSR is sent on a logical channel using a LCID associated with the resources, like the resource pool, from which the UE 400 wishes to request the resources for the sidelink transmission. Sending the request on the logical channel informs the gNB 410 that the UE 400 intends to use resources from a resource pool associated with the logical channel. The UE 400 and the gNB 410 may support more than one logical channel so that different criteria may be mapped to more than one logical channel and may be used simultaneously in time and/or frequency. For example, there may be a mapping between logical channels and resource pools or subbands in the unlicensed spectrum which may be defined in a tabular manner in the standard specification, or which may be configured or preconfigured in the UE 400 by gNB 410.

### Base Station

Further embodiments of the second aspect of the present invention provide a base station, like a gNB or RSU or a similar entity, that is provided to serve a user device for providing, responsive to a request from the user device, resources for a sidelink communication in the unlicensed spectrum. For example, in case a user device sends a BSR on logical channel linked to a particular resource pool, the gNB is expected to allocate resources from the indicated resource pool. FIG. 8 illustrates an embodiment of a gNB 410 in accordance with the second aspect of the present invention. Similar to FIG. 4, the gNB 410 serves a plurality of UEs, like UE 400 and 406 which may communicate with each other over the sidelink 408. UEs 400 and 406 operate in Mode 1, i.e., are connected to the base station 410 via the Uu interfaces 412, 422 and the resource allocation 428 for the sidelink communication over the sidelink 408 is performed by the gNB 410. The signal processor 425 of the gNB 410 is provided so as to allow the gNB to perform the resource allocation as is indicated at 428. The gNB 410 is provided so as to allocate resources for the sidelink communication from the unlicensed spectrum 418 and/or from the licensed spectrum 416, for example from one or more first resource pools, like resource pool 420a including at least some resources in the unlicensed spectrum, and one or more second resource pools, like resource pool 420b including only resources in the licensed spectrum 416. The gNB 410 receives from UE 400 as described above, a request for resources on a certain logical channel associated with one of the resource pools 420a, 420b, as is indicated at 442. Responsive to the request, the gNB 410 allocates resources for the transmission from the resource pool.

In accordance with certain embodiments, the scheduled resources may be linked to the logical channel on which the request was received. For example, as is further indicated at 444, dependent on the logical channel on which the request for resources is received, and which is associated with a certain resource pool, gNB 410, at 428, may perform the allocation of resources from the desired resource pool as indicated implicitly via the transmission of the request on the logical channel.

In accordance with further embodiments, gNB 410, prior to performing the resource allocation in the desired resource pool, in case the logical channel indicates the resource pool to be a resource pool including resources in the unlicensed spectrum 418, the gNB 410 may send a request to UE 400 to provide an occupancy status for some or all of the resources of the resource pool, and dependent on the occupancy report, the gNB 410 may decide to provide resource grants only in the unlicensed spectrum or only in the licensed spectrum or both in the unlicensed spectrum and the licensed spectrum. For example, in case the occupancy report indicates the occupancy of the unlicensed resources to be low, and the request is for resources from the unlicensed spectrum, the gNB 410 may allocate the resources from the requested resource pool in the unlicensed spectrum. In case the occupancy report indicates a certain occupancy of the unlicensed resource, the gNB 410 may decide to allocate some of the resources in the licensed spectrum and some of the resources in the unlicensed spectrum. This may be the case if the gNB wants to reserve a certain number of free resources in the licensed spectrum for potential retransmissions or high-priority transmissions for other UEs to be performed on future resources. Furthermore, by offloading a certain amount of data traffic to the unlicensed band, while also using SL Mode 2 the gNB does not have perform resource allocation for these users, and thus may save its computing resource and either use them for something else or save power by reducing the amount of UEs it has to handle simultaneously. Furthermore, by using both unlicensed and licensed spectrum as much as possible, the gNB may still increase its number of associated or handled UEs and thus reduce the amount of total gNBs that may be required to handle all these UEs in the licensed spectrum. With the number of growing devices, especially wrt. wearables and IoT devices, this may be an efficient way to handle a large number of devices efficiently.

In case the occupancy report indicates that the unlicensed resources are occupied to a degree that is beyond a certain threshold, gNB 410 may decide to disregard the UEs request for resource allocation in the unlicensed spectrum and may, instead, allocate resources only in the licensed spectrum so as to ensure a reliable transmission over the sidelink.

### Third Aspect

Embodiments of the third aspect are now described in more detail. In accordance with embodiments, a UE is provided that receives a resource allocation indicating multiple sets of resources in the licensed spectrum and/or in the unlicensed spectrum for a sidelink transmission, and uses, for the transmission, a set of resources that are judged to be not occupied. In a wireless communication system of the present invention, the gNB is aware of the usage of a resource pool only in so far as the resources are in the licensed spectrum which are all allocated by the gNB and about those resources in the unlicensed spectrum also allocated by the gNB. However, in case there are other users of the unlicensed spectrum, either other 3GPP RAT user devices or other non-3GPP RAT user devices, the gNB is not aware to what extent the resources in the unlicensed spectrum are used by such other devices. Hence, even if the gNB provides a grant to a user device for a sidelink communication, in accordance with embodiments of the third aspect of the present invention, the user device carries out further checks to ensure that the resources from the grant may be used for a transmission.

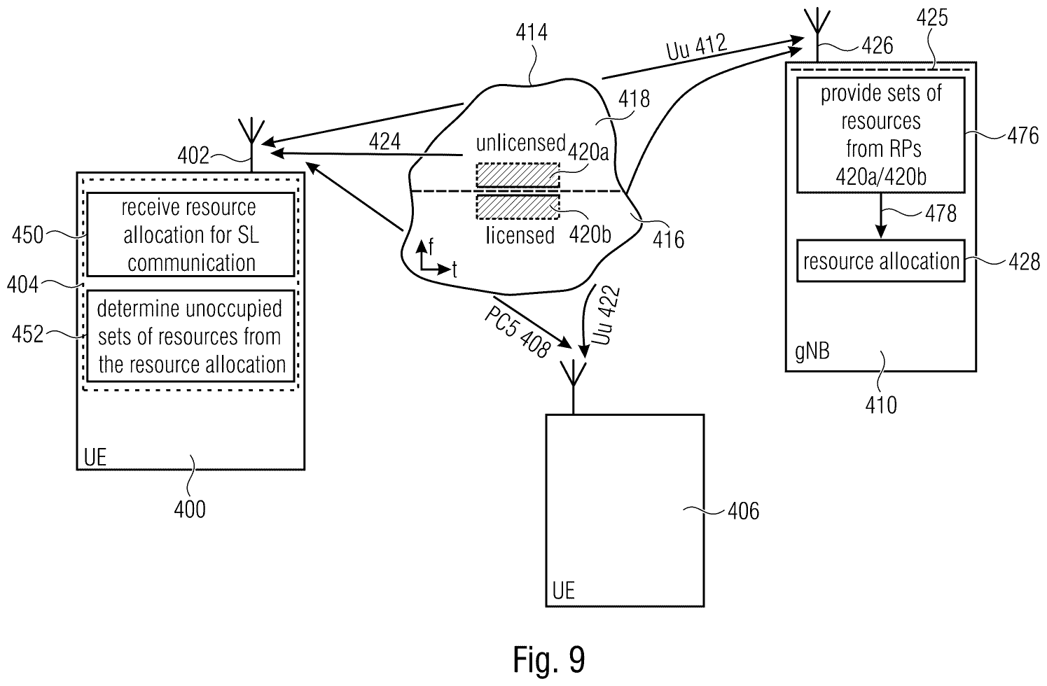

FIG. 9 illustrates a user device 400 in accordance with an embodiment of the third aspect of the present invention. In FIG. 9, similar to FIG. 4 and to FIG. 8, a part of a wireless communication system is depicted including the UEs 400 and 406 which may communicate over the sidelink 408 and which are served by a gNB 410 over the respective Uu interfaces 412, 422. In the system one or more resource pools 420a in the unlicensed spectrum 418 are provided and one or more resource pools 420b in the licensed spectrum 416 are provided. It is noted that each of the resource pools 420a and 420b may be only within the unlicensed/licensed spectrum, however, in accordance with other embodiments, either or both of the resource pools 420a, 420b may also include resources in the licensed/unlicensed spectrum, i.e., resource pool 420a may extend into the licensed spectrum 416 and/or licensed pool 420b may extend into the unlicensed spectrum 418. UE 400 includes the signal processor 404 which is implemented so as to allow UE 400, as is illustrated at 450, to receive from the gNB 410, either directly via the Uu interface 412 or via a relay UE, not depicted in FIG. 9, a resource allocation for the sidelink communication with UE 406 over the sidelink 408. The resource allocation received at 450 includes a plurality of sets of resources from the first resource pool 420a and/or from the second resource pool 420b, and the resources indicated by the gNB in the resource allocation may be used by the UE 400 for the sidelink communication. In accordance with other embodiments, rather than using the allocated resources which are indicated to the UE 400 as being resources available for a sidelink communication for its own transmissions, UE 400 may also forward these available resources to other UEs, like UE 406 which is to perform a transmission over a sidelink communication to another UE or to UE 400. For example, the available resources indicated by the gNB 410 to UE 400 may be forwarded to other UEs which communicate over the sidelink by means of a sidelink assistance information message, AIM.

In accordance with embodiments, the gNB 410 may also indicate to the UE a set of non-preferred resources within the licensed or unlicensed band, which are a set of resource not to be used by the UE. Furthermore, the UE 400 may forward this set of non-preferred resources to another UE, in order to indicate to the other UE that it may avoid performing LBT on these resources and exclude these resources from current and/or future transmissions. The reason for resource exclusion may be that the gNB detected a certain interference on these resources, or that there is a regulatory requirement, which withdraws the permit to transmit on these resources, or that the gNB wants to reserve these resources for a different purpose.

In accordance with embodiments of the third aspect of the present invention, responsive to receiving the resource allocation including the plurality of sets of resources from the respective resource pools 420a, 420b, UE 400, as is indicated at 452, is to determine among the received sets of resources one or more unoccupied sets of resources which may be used by UE 400 for its transmission to another UE over the sidelink or which may be forward to another UE as available resources using, for example, an AIM. In accordance with embodiments, UE 400 may determine unoccupied sets of resources on the basis of measurements 424 like those described above with reference to the first aspect of the present invention. For example, UE 400 may carry out a listen-before-talk, LBT, on unlicensed frequency bands to check whether a grant provided by the gNB in such a band, is occupied or not.

In accordance with embodiments, the process for determining unoccupied sets of resources may be such that, initially, a current set of resources is selected from the plurality of sets provided by the gNB which is then evaluated to see whether it is occupied or non-occupied. In case the current set of resources is not occupied, UE 400 uses the current set of resources for the transmission or forwards the current set of resources in the AIM. Otherwise, i.e., in case the current set of resources is occupied, UE 400 selects from the plurality of sets of resources another, not yet evaluated set of resources as the current set of resources and repeats the above operations. The order in which the UE 400 selects may be configured or preconfigured. The order may depend on the carrier frequency and/or bandwidth used for the carrier. The UE 400 may start with the lowest part of the band, since a lower frequency results in a better radio wave propagation. Furthermore, the order may depend on a current interference. In this case, the UE 400 may pick the set of resource from a frequency range which provides the lowest interference to the UE as possible. In addition, the UE 400 may use some resource for its own transmission. Therefore, it picks orthogonal resources for the other UEs to transmit, if forwarded by an AIM. In case the UE, also denoted as UE-A, forwards a set of resource to another UE-B, and if UE-A is an expected recipient of data from UE-B, then it picks the order of resources in such a way, that it may receive the data in the best possible manner, e.g., without interference from other UEs or gNBs. Further it may select resources based on the receivers Rx abilities, availability or DRX pattern.

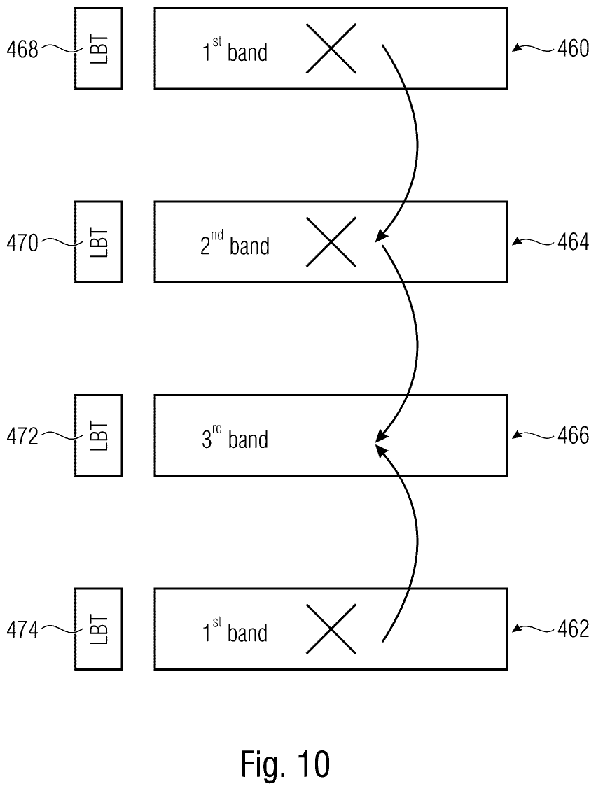

FIG. 10 illustrates the staggered use of frequency bands or subbands based on an occupancy status of licensed and/or unlicensed carriers in accordance with the just described embodiment. In FIG. 10 a primary band 460 for UE 400 is indicated, which may be a frequency band in the licensed and/or unlicensed spectrum. Also, a primary band 462 for another UE, like UE 406, is indicated that may also be a frequency band in the licensed or unlicensed spectrum. The respective primary bands 460, 462 may be signaled by the gNB to the respective UEs, and the frequency bands are respective sets of resources from the resource pools. In addition, secondary and tertiary frequency bands 464 and 466 are indicated which are provided as second and third sets of resources, for example in the resource allocation received at UE 400. Thus, UE 400, in the depicted embodiment, is assumed to received three sets of resources, namely the first band, the second band and third band that may be used for a communication over the sidelink, and the bands may be assumed to be frequency bands in the unlicensed spectrum 418. In accordance with the above-described process, initially, UE 400 performs an LBT procedure 468 so as to determine whether the first band 460 is occupied or not. For the embodiment of FIG. 10, it is assumed that the LBT procedure yields that the first or primary frequency band 460 is occupied, as indicated by the “X”. The process then proceeds to the secondary band 464 for which the LBT procedure 470 also indicates that the second band is occupied as indicated by the “X”. However, the LBT 472 indicates that the tertiary band 466 is non-occupied, and so the UE 400 selects among the sets of resources it obtained by the resource allocation from the gNB the third band 466 for the sidelink communication. FIG. 10 further illustrates the primary frequency band 462 for UE 406 that, for example, receives as resource sets in a resource allocation the bands 462 and 466. At 474 the UE 406 performs a LBT procedure indicating that the primary band 462 is occupied, however, the next set of resources, namely band 466 is determined, by means of the LBT 472, to be not occupied and, therefore, may be used by UE 406.

Thus, in accordance with embodiments of the third aspect of the present invention, the currently applied limitation of a grant being capable of carrying only three TRIV indicated resources is avoided by allowing the gNB 410 to provide multiple sets of resources including, as illustrated in FIG. 10, resources in different subbands. This may be signaled either by downlink control information, DCI, over the Uu interface 412, 422 or by MAC control elements, MAC CE, or by RRC signaling, or by higher layer signaling. The signaling may include multiple TRIV values or, in accordance with other embodiments, the UE may be configured or preconfigured with time/frequency domain allocation patterns that the UE may use. For example, a UE may be RRC configured with a transmission pattern for a number of transmissions, for example for a transmission in the timeslot 0, in the timeslot 3,in the timeslot 5, and in the timeslot 7, and each pattern has an index which is referenced in a DCI to indicate that the UE is to apply the corresponding pattern. The gNB may also provide resources with a grant that map to different subbands and, as is described with reference to FIG. 10, each of the subbands may be labeled as primary, secondary, tertiary subband so that in case of an LBT failure in the primary subband, the UE may fall back to a secondary subband or to a tertiary subband.

In the above-described embodiments, the allocation of the plurality of sets of resources has been described to be indicated in the DCI or MAC CE or RRC by using respective TRIV values. In accordance with other embodiments, also FRIV values may be include for signaling the plurality of sets of resources to the UE. In accordance with other embodiments, the signaling may include the following:
multiple time resource indicator values, TRIVs, and/or multiple frequency resource indicator values, FRIVs, or
a bitmap across time, the bitmap indicating resources, like OFDM symbols or time slots or subframes or frames, where the resource set is defined as spanning either a portion or the entire length of the one BWP, or
a bitmap across frequency, the bitmap indicating resources, like resource blocks, across the one BWP, or
a starting resource in time, like a time slot or a subframe, and a duration of the resource set, or
a starting resource in frequency, like a resource block, and a number of resources for a resource set, or
multiple starting resources, like resource blocks, and ending resources, if the resource set is non-contiguous over frequency, or
explicit resources numbers, like time slot or subframe numbers or explicit resource indices, like resource block indices, or
punctured out resources mentioned explicitly or that are part of another set of resources or RP, or
a starting resource, and periodic offsets for subsequent occurrences, or
a pattern in time, defined by symbols, time slots or subframes or frames, and/or in frequency, defined by resource blocks, subchannels or sub bands,
one or more RRC configured transmission pattern for a number of transmissions.

### Base Station

Further embodiments of the third aspect of the present invention provide a base station or gNB serving one or more user devices capable of performing a sidelink communication. The UE provides further resource allocation for the sidelink communication and sends a plurality of sets of resources from respective resources pools to the sidelink user device. FIG. 9 illustrates an embodiment of the gNB 410 in accordance with the third aspect of the present invention including the signal processor 425 allowing the gNB 410 to perform the resource allocation as indicated at 428. Conventionally, a gNB or base station provides either dynamic or configured grants. In the case of dynamic grants, a gNB currently provides a DCI format 3_0 including TRIV and FRIV. In accordance with embodiments of the third aspect of the present invention, this limitation is overcome by allowing the gNB to provide, for example, multiple TRIVs or FRIVs or bitmaps within a DCI for a dynamic grant. In case of configured grants, the grants are configured by RRC and enabled/disabled using the DCI. For configured grants, and in accordance with embodiments of the third aspect of the present invention, the gNB may provide a grant containing resources from different bands some or all of which are to be activated, and based on the activation of the bands, the UE may carry out the LBT and determine which one to use for its transmission, e.g., in a way as explained above with reference to FIG. 10.

Thus, the gNB 410, in accordance with embodiments of the third aspect of the present invention, selects a plurality of sets of resources from the resource pools 420a, 420b, as is schematically indicated at 476 and provides this selection to the resource allocation 428, as is allocated at 478 so that the resource allocation provided by gNB 410 to the UEs 400, 406 may include the plurality of sets of resources from the resource pool 420a and/or from the resource pool 420b. The gNB 410 may signal the plurality of sets of resources in the resource allocation in a way as described above with reference to the functionality of UE 400.

### Fourth Aspect

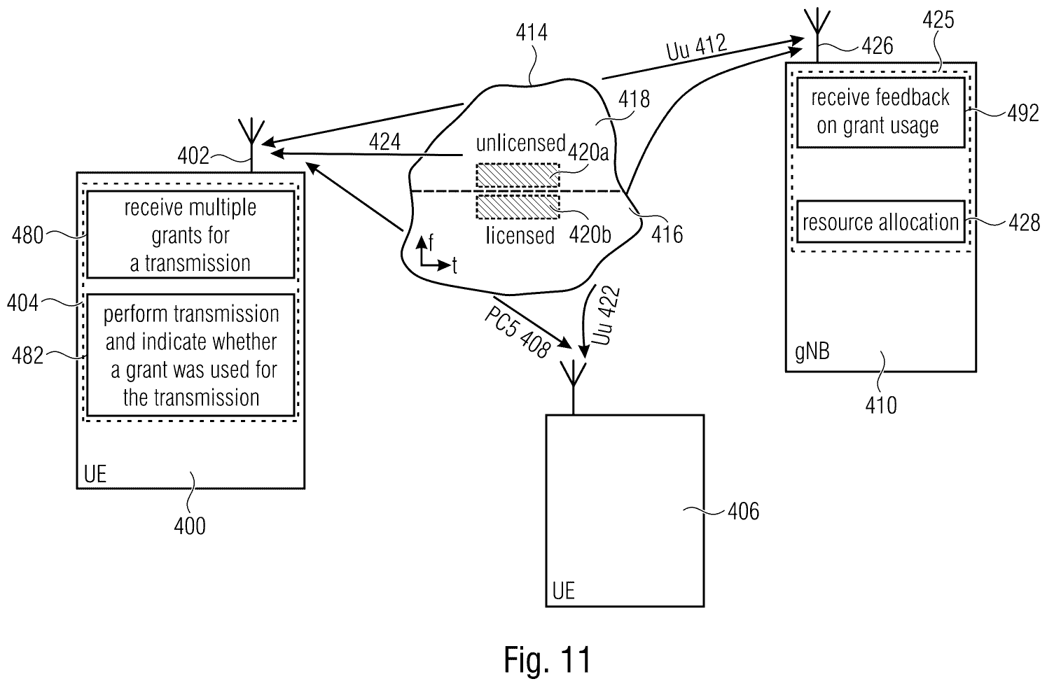

Embodiments of the fourth aspect are now described in more detail. Embodiments of the fourth aspect of the present invention provide an approach for managing multiple grants provided by a base station for a sidelink communication. FIG. 11 illustrates an embodiment of a UE 400 in a wireless communication system, like a 3GPP system. Similar to FIG. 4, the UE 400 communicates over the sidelink 408 with another UE 406 and is operating in Mode 1, i.e., is connected to the gNB 410 for receiving a resource allocation 428 over the Uu interface 412. The gNB 410 may also serve or provide resource allocation for UE 406 over Uu interface 442. UE 400 is configured with at least one resource pool, like resource pool 420a including resources in the unlicensed spectrum. However, resource pool 420a may extend into the licensed spectrum, i.e., may also include resources in the licensed spectrum 416. In accordance with further embodiments, UE 400 may also be configured with a further resource pool in the licensed spectrum 416.

The fourth aspect of the present invention resolves the issue that, conventionally, in NR-U, the gNB provides the UE with multiple grants, and each grant is, basically, an allowance for using or usage of a single time slot by the UE for its own transmission. In case the gNB provides the UE with multiple grants, it is not specified how the UE manages each of the respective grants, especially in cases where the UE has only a single packet to transmit, after a successful transmission in the first grant, the remaining grants already scheduled are not used by the UE.

As is indicated at 480 UE 400 receives from the gNB 410, either directly over the Uu interface 412 or over a relay UE, not depicted in FIG. 11, multiple grants or a plurality of grants for a transmission. When providing the information via the Uu interface 412, the multiple grants may be included in the DCI, and in case the multiple grants are received via a sidelink communication from a relay, there may be included in a SCI. Each of the plurality of grants includes one or more resources selected from the sidelink pool 420a and/or from the sidelink pool 420b for a communication with UE 406 over the sidelink 408. Responsive to receiving the multiple grants, UE 400 performs a transmission and, as is signaled at 482, indicates for each grant whether the grant or the resources within the grant are to be used by the UE 400 for performing the transmission or were used by UE 400 for performing the transmission.

In accordance with embodiments, the UE may indicate for some or all of the grants, whether the respective grants are to be used or were used for the transmission. In accordance with other embodiments, the UE 400 may indicate explicitly which one of the grants was used for the transmission and/or which one was not used for the transmission. In accordance with yet other embodiments, the UE may also indicate a certain subset of grants that were used. For example, in case of dynamic grants, there may be three resources configured, but, e.g., only one was used. This may be signaled to the gNB so that the gNB may determine if it needs to provide more grants, or grants in a different RP. In accordance with embodiments, the UE 400 may receive a further grant from the gNB 410 or another UE depending on the previous report of used grants. For example, the further grants received may be one or more of a configured grant type 1, a configured grant type 2, a dynamic grant, a sidelink AIM, e.g., another UE or GL-UE.

Thus, embodiments of the fourth aspect of the present invention provide a feedback by the UE towards the gNB informing the gNB, in case multiple grants were provided by the gNB, about the usage status of a certain grant. Conventionally, the feedback mechanism used in NR sidelink communications is to send from the UE to the gNB the feedback only at the end of all grants so that the gNB may not be aware that the UE actually did not need or require all grants originally scheduled by the gNB. To address this drawback, in accordance with embodiments of the fourth aspect of the present invention, after one or more or each grant, UE 400 may send a feedback about whether the current grant was used by the UE, i.e., as to whether the resources indicated by a current grant were used for a transmission or not. In the latter case, this means that the transmission has been completed so that all future grants are no longer required by the UE for the transmission and the gNB may release these grants or resources to be used for further grants to be assigned to the UE 400 or to another UE, like UE 406.

In accordance with embodiments, this information may be sent explicitly using a feedback message, or it may be included or piggybacked with another control message provided by UE 400 to the gNB 410, for example, it may be piggybacked with a BSR. In accordance with other embodiments, this information may be included into an occupancy status report, like the report explained above with reference to the embodiments of the first aspect of the present invention.

In accordance with other embodiments of the fourth aspect, rather than sending the information or feedback signaling unused resources to the gNB 410 so as to allow for a release of the resources, this information or feedback may also be forwarded to other UEs operating in the system for a communication over the sidelink, for example by means of an AIM, thereby informing other UEs about further available resources that may be used, for example, by UEs operating in Mode 2.

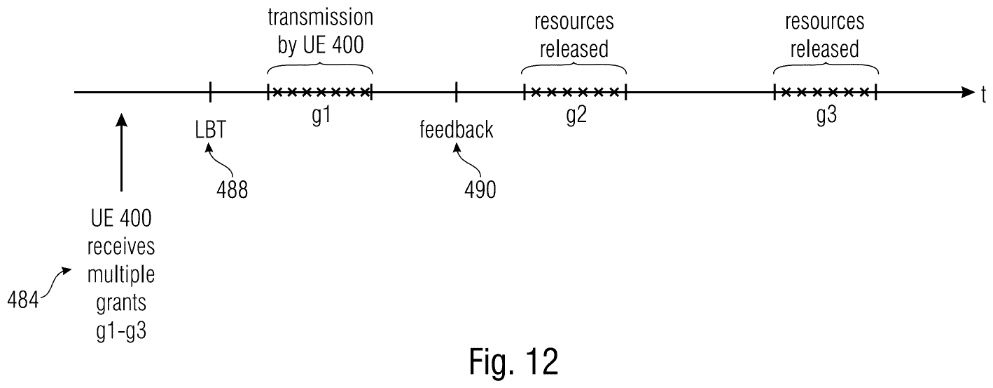

FIG. 12 illustrates an embodiment providing a UE with several grants available for a given transmission which are not all required since a transmission is completed without using all of the resources in the grants, for example because the transmission includes less data packets to transmit than expected. As indicated at 484, the UE 400 receives multiple grants g1 to g3 which, as indicated in the embodiments are three sets of consecutive time slots as indicated at g1, g2, and g3. It is assumed that at least the first grant includes resources in the unlicensed spectrum so that the UE, as is indicated at 488, for performing its transmission, carries out an LBT procedure so as to determine whether the resources of grant g1 are non-occupied or available. Assuming that the LBT is successful, i.e., the resources for grant g1 are available, the UE 400 performs the transmission using the resources in the unlicensed spectrum indicated in g1, for example using the resources allocated in the unlicensed resource pool 420a for the sidelink communication. It is further assumed that the amount of data to be transmitted by the transmission is such that the transmission may be completed by using the resources of grant g1, i.e., the resources of grant g2 and grant g3 are no longer needed. Therefore, as is indicated at 490, the UE 400, being aware that its transmission for which it received the multiple grants, is already completed, signals the feedback or AIM to the gNB 410 or to another UE informing them that the resources associated with grants g2 and g3 which may be resources from the unlicensed resource pool 420a and/or resources from the licensed resource pool 420b are no longer needed by UE 400 and may be released.

In accordance with other embodiments, UE 400 may request for the initial transmission of a TB also resources for two retransmissions, and, in turn, receives, as is shown in FIG. 12, the multiple grants g1 to g3 of which the resources of grant g1 are used for the transmission and the resources of grants g2 and g3 may be used for retransmissions. In accordance with embodiments of the fourth aspect of the present invention, UE 400 sends the grant usage feedback to the gNB after each grant that was used, as is indicated at 490 in FIG. 12. When considering FIG. 12 and assuming that UE 400 was able to successfully carry out the transmission in the first attempt using the resources in grant g1, the remaining grants g2 and g3 are no longer required as no retransmission is needed. Hence, by means of the feedback 490 this may be signaled to the gNB 410 or via an AIM to another UE, so that the gNB 410 may reuse the resources of the grants g2 and g3 for other UEs.

In accordance with other embodiments, rather than informing the gNB, UE 400 may signal to another UE, like 406, that the resources for grants g2 and g3 are not used by UE 400 but are available for sidelink communication by UE 406. This information may be included in a sidelink assistance information message. UE 400, in such embodiments, may act, for example, as a scheduling UE or as a group leader UE, GL-UE. The signaling of the no longer needed resources from grants g2 and g3 may be either a signaling via broadcast, unicast or groupcast to one, some or all UEs communicating over the sidelink within the communication range of UE 400.

In accordance with yet other embodiments, rather than indicating the usage of the grants to other devices, it may be used internally within UE 400. The feedback 490 indicated in FIG. 12 is not transmitted to the gNB or to a UE, rather the finding that the transmission for which the grants g1 to g3 were obtained was completed already by using the resources of grant g1 is used internally so as to allow UE 400 to use the resources of grants g2 and g3 to transmit other packets the UE may have in its transmission buffer. In other words, UE 400 does not indicate to the gNB or to another UE that the resources or grants g2, g3 may be released but uses the grants for transmitting the further packets it has.

In accordance with yet further embodiments, UE 400 may use the additional grants g2 and g3 in FIG. 12 not for transmitting other packets that may be within the UE's buffer but it may use the additional grants for redundancy transmissions of the original transmission performed using the resources in grant g1, for example by duplicating the message transmitted by the transmission using grant g1 and sending it using the resources of grants g2 and g3. For example, this may be advantageous in case the original transmission using grant g1 included a warning or alert message, so that sending it several times using the resources of grants g2 and g3 allows increasing the reach of the given message.

In accordance with embodiments, the UE 400, when using the resources for grants g2 and g3 for other data packets or for redundancy transmissions, may consider to change the MCS or beamformer so that the duplicated messages or a redundancy transmission are transmitted using different characteristics thereby improving the chances of successfully transmitting the data to the intended recipients.

Further embodiments of the fourth aspect of the present invention provide a base station for providing Mode 1 sidelink user devices with several grants and receiving for each grant a feedback on the use of a certain grant. FIG. 11 illustrates an embodiment of a gNB 410 in accordance with the fourth aspect of the present invention which provides for the resource allocation 428 for a sidelink communication among sidelink UEs, like UEs 400 and 406. The gNB 410 is providing the resource allocation to the UEs via the Uu interfaces 412, 416 and, in accordance with embodiments, as is indicated at 492 receives a feedback on the grant usages. More specifically gNB 410 allocates a plurality of grants to UE 400 and, as described above, receives a feedback indicating the usage of the grants, for example in a way as explained with reference to the embodiment of FIG. 12. Responsive to a feedback indicating that a certain grant is not used, the gNB 410 may determine that all remaining grants of the plurality of grants provided to the UE 400 are not used and released and, therefore, may use the resources associated with the unused grants for the resource allocation 428 for another transmission for UE 400 or for transmissions for other UEs, like UE 406.

### General

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a network entity comprises one or more of the following: a macro cell base station, or a small cell base station, or a central unit of a base station, an integrated access and backhaul, IAB, node, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

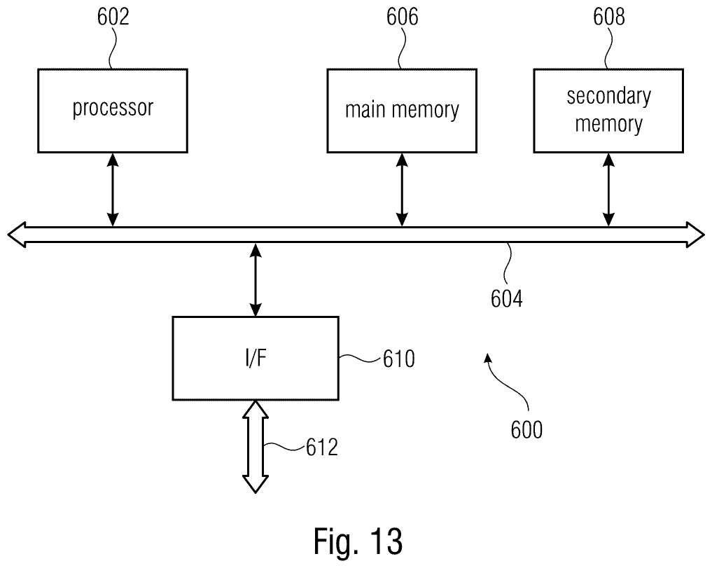

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 13 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A user device, UE, for a wireless communication system, like a 3^{rd} Generation Partnership Project, 3GPP, system,
wherein the UE is to communicate using a sidelink, SL, using resources allocated by a base station of the wireless communication system,
wherein the UE is configured or preconfigured with at least one first SL resource pool and with at least one second SL resource pool,
wherein the UE is to receive from the base station, directly or via another UE, a resource allocation for a transmission using the SL, the resource allocation comprising a plurality of sets of resources from one or more of the first and second SL resource pools, each set of resources available for the UE to carry out the transmission or to be signaled to a further UE as resources available or not available or as a preferred or non-preferred set of resources to be used for a transmission by the further UE, e.g., using an assistance information message, AIM, and
wherein the UE is to determine among the plurality of sets of resources an unoccupied set of resources and to carry out the transmission using the unoccupied set of resources or to signal to the further UE the unoccupied set of resources as the available resources.

2. The user device UE of claim 1,
wherein the first SL resource pool comprises:
only resources in a licensed spectrum, or
only resources in an unlicensed spectrum, or
resources both in the licensed spectrum and in the unlicensed spectrum, and
wherein the second SL resource pool comprises:
only resources in the licensed spectrum, or
only resources in the unlicensed spectrum, or
resources both in the licensed spectrum and in the unlicensed spectrum.

3. The user device, UE, of claim 1, wherein the UE is to
(a) select from the plurality of sets of resources a current set of resources,
(b) evaluate whether the current set of resources is occupied or unoccupied,
(c) in case the current set of resources in unoccupied, use the current set of resources for the transmission,
(d) in case the current set of resources is occupied, select from the plurality of sets of resources another, not yet evaluated set of resources as the current set of resources and repeat operations (a) to (d).

4. The user device, UE, of claim 3, wherein.
the first SL resource pool includes resources only in the unlicensed spectrum,
the second SL resource pool includes resources only in the licensed spectrum,
the resource allocation comprises one or more sets of resources in the first SL resource pool and in the second SL resource pool, and
in case none of the sets of resources in the first SL resource pool is unoccupied, the UE is to use for the transmission the set of resources in the second SL resource pool.

5. The user device, UE, of claim 1, wherein the allocation of the plurality of sets of resources in the first and second SL resource pools, e.g., in a Downlink Control Information, DCI, or in a MAC CE or RRC or by higher layer signaling, includes:
multiple time resource indicator values, TRIVs, and/or multiple frequency resource indicator values, FRIVs, or
a bitmap across time, the bitmap indicating resources, like OFDM symbols or time slots or subframes or frames, where the resource set is defined as spanning either a portion or the entire length of the one BWP, or
a bitmap across frequency, the bitmap indicating resources, like resource blocks, across the one BWP, or
a starting resource in time, like a time slot or a subframe, and a duration of the resource set, or
a starting resource in frequency, like a resource block, and a number of resources for a resource set, or
multiple starting resources, like resource blocks, and ending resources, if the resource set is non-contiguous over frequency, or
explicit resources numbers, like time slot or subframe numbers or explicit resource indices, like resource block indices, or
punctured out resources mentioned explicitly or that are part of another set of resources or RP, or
a starting resource, and periodic offsets for subsequent occurrences, or
a pattern in time, defined by symbols, time slots or subframes or frames, and/or in frequency, defined by resource blocks, subchannels or sub bands,.
one or more RRC configured transmission pattern for a number of transmissions.

6. The user device, UE, of claim 1, wherein a set of resources of the first SL resource pool comprises one or more of the following:
one or more symbols,
one or more time slots or subframes or frames,
one or more LBT sub-bands,
one or more frequencies or carriers,
one or more frequency bands, like unlicensed subbands,
one or more spatial resources, e.g., using spatial multiplexing.

7. A base station for a wireless communication system, like a 3^{rd} Generation Partnership Project, 3GPP, system, the wireless communication system comprising a plurality of sidelink user devices, SL-UEs, communicating using a sidelink, SL,
wherein the base station is to provide to a SL UE, directly or via another UE, a resource allocation for a transmission by the SL UE using the SL, the resource allocation comprising a plurality of sets of resources from at least one first SL resource pool and/or from at least one second SL resource pool, each set of resources available for the UE to carry out the transmission or to be signaled to a further UE as resources available for a transmission by the further UE, e.g., using an assistance information message, AIM.

8. The base station of claim 7,
wherein the first SL resource pool comprises:
only resources in a licensed spectrum, or
only resources in an unlicensed spectrum, or
resources both in the licensed spectrum and in the unlicensed spectrum, and
wherein the second SL resource pool comprises:
only resources in the licensed spectrum, or
only resources in the unlicensed spectrum, or
resources both in the licensed spectrum and in the unlicensed spectrum.

9. The base station of claim 7, wherein the allocation of the plurality of sets of resources in the first and second SL resource pools, e.g., in a Downlink Control Information, DCI, or in a MAC CE or via RRC or by higher layer signaling, includes:
multiple time resource indicator values, TRIVs, and/or multiple frequency resource indicator values, FRIVs, or
a bitmap across time, the bitmap indicating resources, like OFDM symbols or time slots or subframes or frames, where the resource set is defined as spanning either a portion or the entire length of the one BWP, or
a bitmap across frequency, the bitmap indicating resources, like resource blocks, across the one BWP, or
a starting resource in time, like a time slot or a subframe, and a duration of the resource set, or
a starting resource in frequency, like a resource block, and a number of resources for a resource set, or
multiple starting resources, like resource blocks, and ending resources, if the resource set is non-contiguous over frequency, or
explicit resources numbers, like time slot or subframe numbers or explicit resource indices, like resource block indices, or
punctured out resources mentioned explicitly or that are part of another set of resources or RP, or
a starting resource, and periodic offsets for subsequent occurrences, or
a pattern in time, defined by symbols, time slots or subframes or frames, and/or in frequency, defined by resource blocks, subchannels or sub bands,
one or more RRC configured transmission pattern for a number of transmissions.

10. The user device, UE, of claim 1, wherein the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a SL UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

11. The base station of claim 7, wherein the base station comprises one or more of a macro cell base station, or a small cell base station, or a central unit of a base station, or a distributed unit of a base station, or an Integrated Access and Backhaul, IAB, node, or a road side unit, RSU, or a UE, or a SL UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

12. A method for operating a method for operating a user device, UE, for a wireless communication system, like a 3^{rd} Generation Partnership Project, 3GPP, system, wherein the UE is to communicate using a sidelink, SL, using resources allocated by a base station of the wireless communication system, and wherein the UE is configured or preconfigured with at least one first SL resource pool and with at least one second SL resource pool, the method comprising:
receiving from the base station, directly or via another UE, a resource allocation for a transmission using the SL, the resource allocation comprising a plurality of sets of resources from one or more of the first and second SL resource pools, each set of resources available for the UE to carry out the transmission or to be signaled to a further UE as resources available or not available or as a preferred or non-preferred set of resources to be used for a transmission by the further UE, e.g., using an assistance information message, AIM, and
determining among the plurality of sets of resources an unoccupied set of resources and to carry out the transmission using the unoccupied set of resources or to signal to the further UE the unoccupied set of resources as the available resources.

13. The method of claim 12, comprising:
providing, by the base station, to the SL UE, directly or via another UE, the resource allocation for the transmission by the SL UE using the SL.
